(19) United States
(12) Patent Application Publication
(10) Pub. No.: US 2025/0348479 A1
(43) Pub. Date: Nov. 13, 2025

(54) METHODS AND SYSTEMS FOR EXPLAINABLE TEMPLATE RETRIEVAL FOR OPTIMIZATION MODELING

(71) Applicant: Huawei Cloud Computing Technologies Co., Ltd., Guizhou (CN)

(72) Inventors: Timothy Tin Long YU, Kanata (CA); Rindranirina RAMAMONJISON, Kanata (CA); Mahdi MOSTAJABDAVEH, Kanata (CA); Yong ZHANG, Kanata (CA)

(21) Appl. No.: 19/275,123

(22) Filed: Jul. 21, 2025

Related U.S. Application Data
(63) Continuation of application No. PCT/CN2023/078013, filed on Feb. 24, 2023.

(51) Int. Cl. G06F 16/242

(52) U.S. Cl. CPC G06F 16/2425; G06F 16/243

(57) ABSTRACT

Methods and systems for context-grounded, incremental generation of an optimization model are described. Natural language contextual information of an optimization problem is received. A structured model summary data structure is updated by retrieving templates for model components, each of the one or more templates being retrieved using a respective refined query generated from the contextual information. A base model template is retrieved using the structured model summary data structure as a query. A symbolic model associated with the base model template is updated by retrieving additional templates for additional model components, each of the templates being retrieved using a respective additional refined query. The symbolic model is updated using symbolic content associated with each of the retrieved templates. The symbolic model is outputted as a generated optimization model.

### CROSS-REFERENCE TO RELATED APPLICATIONS

The present disclosure is a continuation of PCT Application No. PCT/CN2023/078013, filed on Feb. 24, 2023, entitled “METHODS AND SYSTEMS FOR EXPLAINABLE TEMPLATE RETRIEVAL FOR OPTIMIZATION MODELING”, the disclosure of which is hereby incorporated by reference in its entirety.

### TECHNICAL FIELD

The present disclosure relates to methods and systems for generating a model for solving an optimization problem using an explainable template retrieval system.

### BACKGROUND

Many real-world problems are optimization problems, such as how to minimize usage of a limited resource or how to maximize throughput of a system. In many cases, these optimization problems are complex (e.g., having many different constraints, many different conditions, many different variables, etc.) and cannot be practically solved by humans. Optimization solvers (also simply referred to as “solvers”) are software tools that have been developed to solve such optimization problems. In order for the optimization problem to be understood by a solver, the optimization problem is structured as an optimization model, which includes mathematical representation of the decision variable(s), constraint(s) and objective(s) of the optimization problem.

A conventional process for generating an optimization model typically involves a human (e.g., business owner) who has knowledge about the optimization problem and its context first describing the optimization problem in a non-technical way, for example in a natural language document (referred to herein as the problem specification). The problem specification is then converted, by another human (e.g., an operations research (OR) expert), into an optimization model and the model is instantiated into a model instance using actual numerical data. The model instance is in the form of computer-readable code that can be inputted to the solver. However, it typically requires many iterations of questioning, modeling and validating between a non-OR expert (e.g., the human who posed the optimization problem) and an OR expert before a final optimization model that is satisfactory to both the non-OR expert and the OR expert. This process can be inefficient, both in time and resources. The need for an OR expert also limits the practical use of solvers since the OR expert can become a bottleneck.

It would be useful to provide a solution that can improve the accessibility of solvers and/or improve the efficiency in modeling optimization problems.

### SUMMARY

In various examples, the present disclosure describes an explainable template retrieval system that enables an optimization model to be generated from a non-technical, natural language document describing an optimization problem. The explainable template retrieval system may include subsystems such as a query refiner, a template retriever and an explanation generator.

The disclosed methods and systems may enable retrieval of a template based on a problem specification that provides a natural language textual description of the optimization problem. The disclosed methods and systems may also generate an explanation for the retrieved template in which the explanation is based on the context of the problem description. This provides an advantage in that the explanation for a retrieved template may provide information to assist in understanding the template in the context of the particular problem, rather than being a generic description of the template.

Examples of the present disclosure may use machine learning to process a natural language problem specification and to assist a human user in building an optimization model. This provides an advantage in that a non-technical user may be able to generate an optimization model for a particular optimization problem without having to manually create code or mathematical equations to represent the optimization problem. The user may be able to incrementally build upon an existing model template in order to generate an optimization model that is tailored to the particular optimization problem.

In an example aspect, the present disclosure describes a computing system including a processing unit configured to execute computer-readable instructions to cause the system to: receive, from a user device, contextual information containing a textual description of an optimization problem in natural language; update a structured model summary data structure by retrieving, from a template database, one or more templates for one or more model components, each of the one or more templates being retrieved using a respective refined query generated from the contextual information, and updating the structured model summary data structure using metadata associated with each of the retrieved one or more templates; retrieve a base model template using the structured model summary data structure as a query to the template database; update a symbolic model associated with the base model template by retrieving, from the template database, one or more additional templates for one or more additional model components, each of the one or more templates being retrieved using a respective additional refined query, and updating the symbolic model using symbolic content associated with each of the retrieved one or more templates; and output the symbolic model as a generated optimization model.

In an example of the preceding example aspect of the system, updating the structured model summary data structure may include updating the contextual information using metadata associated with the retrieved one or more templates, and wherein the updated contextual information is outputted.

In an example of any of the preceding example aspects of the system, updating the structured model summary data structure may be performed iteratively, and the structured model summary data structure may be updated using metadata associated with one retrieved template for one model component in each iteration

In an example of the preceding example aspect of the system, updating the symbolic model may be performed iteratively, and the symbolic model may be updated using symbolic content associated with one retrieved template for one model component in each iteration.

In an example of any of the preceding example aspects of the system, updating the structured model summary data structure may include generating a context-grounded explanation for each retrieved one or more templates, and the context-grounded explanation may be presented via the user device.

In an example of any of the preceding example aspects of the system, updating the structured model summary data may include presenting, via the user device, at least one refined query, and receiving approval, via the user device, of the at least one refined query prior to using the at least one refined query to retrieve a respective at least one template.

In an example of any of the preceding example aspects of the system, the processing unit may be further configured to executing computer-readable instructions to cause the system to: after retrieving the base model template, present, via the user device, a generated explanation for the base model template, the generated explanation being generated from metadata associated with the base model template and the contextual information.

In an example of any of the preceding example aspects of the system, updating the symbolic model may include presenting, via the user device, at least one additional refined query, and receiving approval, via the user device, of the at least one additional refined query prior to using the at least one additional refine query to retrieve a respective at least one template.

In an example of any of the preceding example aspects of the system, the at least one refined query may be generated from an initial query received from the user device.

In an example of any of the preceding example aspects of the system, the processing unit may be further configured to execute computer-readable instructions to cause the system to: provide a user interface (UI) to the user device, wherein the contextual information is received as natural language input from the user device via the UI.

In an example of any of the preceding example aspects of the system, the processing unit may be further configured to execute computer-readable instructions to cause the system to implement a refined query generator including: a first natural language processing (NLP) encoder trained to encode context segments, segmented from the contextual information, into respective context vectors and to encode an initial query into a query vector, wherein the context vectors and the query vector are encoded into a common vector space; a first similarity module configured to select at least one selected context segment based on a similarity between the query vector and the context vector encoded from the at least one selected context segment; and a first NLP generative model trained to generate at least one refined query based on the initial query and the at least one selected context segment.

In an example of the preceding example aspect of the system, the processing unit may be further configured to execute computer-readable instructions to cause the system to implement a template retriever including: a second NLP encoder trained to encode the at least one refined query into a refined query vector and to encode metadata associated with each one or more templates into respective one or more template vectors, wherein the one or more template vectors and the refined query vector are encoded into a common vector space; and a second similarity module configured to select at least one selected template to be retrieved based on a similarity between the refined query vector and the template vector encoded from metadata associated with the at least one selected template.

In an example of the preceding example aspect of the system, the processing unit may be further configured to execute computer-readable instructions to cause the system to implement an explanation generator including: a second NLP generative model trained to generate a context-grounded explanation for the at least one selected template based on the metadata associated with the at least one selected template and the refined query.

In an example aspect, the present disclosure describes a method including: receiving, from a user device, contextual information containing a textual description of an optimization problem in natural language; updating a structured model summary data structure by retrieving, from a template database, one or more templates for one or more model components, each of the one or more templates being retrieved using a respective refined query generated from the contextual information, and updating the structured model summary data structure using metadata associated with each of the retrieved one or more templates; retrieving a base model template using the structured model summary data structure as a query to the template database; updating a symbolic model associated with the base model template by retrieving, from the template database, one or more additional templates for one or more additional model components, each of the one or more templates being retrieved using a respective additional refined query, and updating the symbolic model using symbolic content associated with each of the retrieved one or more templates; and outputting the symbolic model as a generated optimization model.

In an example of the preceding example aspect of the method, updating the structured model summary data structure may include updating the contextual information using metadata associated with the retrieved one or more templates, and the updated contextual information may be outputted.

In an example of any of the preceding example aspects of the method, updating the structured model summary data structure may be performed iteratively, and the structured model summary data structure may be updated using metadata associated with one retrieved template for one model component in each iteration.

In an example of the preceding example aspect of the method, updating the symbolic model may be performed iteratively, and the symbolic model may be updated using symbolic content associated with one retrieved template for one model component in each iteration.

In an example of any of the preceding example aspects of the method, updating the structured model summary data structure may include generating a context-grounded explanation for each retrieved one or more templates, and the context-grounded explanation may be presented via the user device.

In an example of any of the preceding example aspects of the method, updating the structured model summary data may include presenting, via the user device, at least one refined query, and receiving approval, via the user device, of the at least one refined query prior to using the at least one refined query to retrieve a respective at least one template.

In an example of any of the preceding example aspects of the method, the method may include: after retrieving the base model template, presenting, via the user device, a generated explanation for the base model template, the generated explanation being generated from metadata associated with the base model template and the contextual information.

In an example of any of the preceding example aspects of the method, updating the symbolic model may include presenting, via the user device, at least one additional refined query, and receiving approval, via the user device, of the at least one additional refined query prior to using the at least one additional refine query to retrieve a respective at least one template.

In an example of any of the preceding example aspects of the method, the at least one refined query may be generated from an initial query received from the user device.

In an example of any of the preceding example aspects of the method, the method may include: providing a user interface (UI) to the user device, wherein the contextual information is received as natural language input from the user device via the UI.

In an example of any of the preceding example aspects of the method, the method may include executing a refined query generator including: a first natural language processing (NLP) encoder trained to encode context segments, segmented from the contextual information, into respective context vectors and to encode an initial query into a query vector, wherein the context vectors and the query vector are encoded into a common vector space; a first similarity module configured to select at least one selected context segment based on a similarity between the query vector and the context vector encoded from the selected context segment; and a first NLP generative model trained to generate at least one refined query based on the initial query and the at least one selected context segment.

In an example of the preceding example aspect of the method, the method may include executing a template retriever including: a second NLP encoder trained to encode the at least one refined query into a refined query vector and to encode metadata associated with each one or more templates into respective one or more template vectors, wherein the one or more template vectors and the refined query vector are encoded into a common vector space; and a second similarity module configured to select at least one selected template to be retrieved based on a similarity between the refined query vector and the template vector encoded from metadata associated with the at least one selected template.

In an example of the preceding example aspect of the method, the method may include executing an explanation generator including: a second NLP generative model trained to generate a context-grounded explanation for the at least one selected template based on the metadata associated with the at least one selected template and the refined query.

In another example aspect, the present disclosure describes a non-transitory computer readable medium having machine-executable instructions stored thereon, where the instructions, when executed by a processing unit of an apparatus, cause the apparatus to perform the method of any one of the preceding example aspects of the method.

### BRIEF DESCRIPTION OF THE DRAWINGS

Reference will now be made, by way of example, to the accompanying drawings which show example embodiments of the present application, and in which:

FIG. 1 is a block diagram of an example explainable template retrieval system, in accordance with examples of the present disclosure;

FIG. 2 is a block diagram of an example computing system that may be used to implement examples of the present disclosure;

FIG. 3A is a block diagram illustrating components of an example refined query generator, which may be used in the system of FIG. 1, in accordance with examples of the present disclosure;

FIG. 3B illustrates an example of how the refined query generator of FIG. 3A may generate a refined query, in accordance with examples of the present disclosure;

FIG. 4A is a block diagram illustrating components of an example template retriever, which may be used in the system of FIG. 1, in accordance with examples of the present disclosure;

FIG. 4B illustrates an example of how the template retriever of FIG. 4A may retrieve a template, in accordance with examples of the present disclosure;

FIG. 5A is a block diagram illustrating components of an example explanation generator, which may be used in the system of FIG. 1, in accordance with examples of the present disclosure;

FIG. 5B illustrates an example of how the explanation generator of FIG. 5A may generate an explanation, in accordance with examples of the present disclosure;

FIG. 6 is a flowchart illustrating an example incremental modeling method, in accordance with examples of the present disclosure;

FIGS. 7-9 are a flowcharts illustrating examples for implementing steps of the incremental modeling method of FIG. 6, in accordance with examples of the present disclosure; and

FIGS. 10A-10G illustrate example user interfaces that may be provided in accordance with examples of the present disclosure.

Similar reference numerals may have been used in different figures to denote similar components.

### DETAILED DESCRIPTION

To assist in understanding the present disclosure, some background discussion of optimization problems and optimization models is first provided.

Generally, an optimization problem describes a decision-making scenario that involves an objective to be minimized or maximized. The problem specification defines the optimization problem in natural language. Often, the problem specification is created by a domain expert who understands the context of the problem but may not be able to express the problem in a mathematical or technical manner. Often, the problem specification may be ambiguous and/or unstructured. The problem specification provides context for the problem and provides background information may help to provide clarity to ambiguous terms or information. In general, the problem specification sets out the objective(s) to be optimized, the decision variables that can be adjusted to optimize the objective(s), the symbolic parameters that define the parameters of the objective(s) and constraint(s) of the problem. However, the problem specification may set out these components of the optimization problem in an ambiguous manner that requires context to be meaningful. For example, the problem specification may contain a natural language phrase such as “The cost should be minimized” that is ambiguous and lacking in context. The context of this phrase may be that the “cost” refers to the cost of hourly wages for drivers and is affected by the travel time required for each driver.

For the optimization problem to be understandable and solvable by an optimization solver (referred to hereafter as simply “solver” or “software solver”), the optimization problem must be structured as an optimization model. An optimization model includes a symbolic model and semantic metadata. The symbolic model is a symbolic and context-free representation of the optimization problem, typically represented using a modeling language or programming language (i.e., not natural human language). The symbolic model may mathematically represent the objective(s) of the optimization problem (which may be represented as mathematical functions to be optimized and which may be parameterized by symbolic parameters), may include mathematical representations of constraints (e.g., an equality constraint or inequality constraint), and may include model entities (e.g., indexed decision variables or parameters). Semantic metadata provides information that describes the meaning of the mathematical representations in the symbolic model, for example the semantic metadata may include an objective name that gives meaning to the objective function (e.g., “maximize the production amount”), constraint attribute that gives the constraint sense (e.g., right hand side expression), or model attribute that provides a model name and information about the number of constraints variables, among others.

It should be noted that the optimization model may need to be instantiated with actual data values in order to be solved by a solver. When the data parameters of the symbolic model are given actual data values (e.g., from a real-world scenario), the symbolic model is instantiated and a model instance is created, which is a specific instance of the symbolic model in the form of computer-readable code that can be inputted to a solver to generate a solution to the optimization problem. There are various solvers that can be used to solve different optimization problems and each solver may require different specific structured inputs (e.g., specific keywords, specific order of code, etc.) to be provided by the model instance.

Generating an optimization model typically requires the skill of an operations research (OR) expert to convert the natural language problem specification into the optimization model (e.g., to convert an objective from natural language into a mathematical function that can be optimized). However, the optimization model may be difficult to be understood by the domain expert who is not an OR expert. Accordingly, it can be difficult for the domain expert to verify whether the optimization problem has been accurately represented in the optimization model and thus it is difficult for the domain expert to validate and make use of the optimization model. As well, it can be difficult for the domain expert to make even slight changes to the optimization model (e.g., to adjust a decision variable or parameter) without help from the OR expert.

There has been interest in using machine learning to help improve the efficiency of the process for generating an optimization model. Some existing solutions help a user to generate an optimization model by guiding a user through a series of questions to arrive at a base model that can then be adjusted by adding additional model components. However, the process of guided questions can be restrictive and non-intuitive to a user. There is also interest in the use of natural language processing (NLP) machine learning models that can accept natural language inputs instead of a programming language. For example, existing solutions include explainable information retrieval systems, which are systems that perform document retrieval in response to a query and aim to prove an explanation of how a retrieved document is relevant to the query. However, many of the existing explainable information retrieval systems may not enable a query to be refined using contextual information and may not provide explanations that can be tailored to the context of the user.

In general, a solution that can accept natural language description of an optimization problem, generate a suitable optimization model and provide context-grounded explanation of the model would be desirable to help address some or all of the drawbacks of existing solutions. In various examples, the present disclosure describes methods and systems that enable an optimization model to be generated based on a natural language problem specification, and that provides context-grounded explanations to enable validation of the model and improve efficiency of model generation. An explainable template retrieval system is disclosed as well as a method of using the explainable template retrieval system in an incremental modeling framework for generating an optimization model.

Examples of the present disclosure may be implemented as an online service, mobile applications or other computer-assisted design software applications. Examples of the present disclosure may enable a user to provide a natural language input for incrementally building an optimization model. Context-grounded explanations may be generated to help explain and guide the model building process.

Examples of the present disclosure may provide a more intuitive and flexible method for model generation. For example, rather than restricting a user to a predefined decision tree, examples of the present disclosure may adapt to the information provided in a problem specification and enable user interaction to build model components according to the specific optimization problem. Examples of the present disclosure may also provide a user interface that enables a user to modify the model and model components, without requiring the user to be knowledgeable about optimization modeling or coding.

Examples of the present disclosure may, in addition to generating the optimization model, generate an annotated version of the optimization specification that may serve as documentation of the optimization model and building process. In this way, the transparency of the optimization model may be improved and the need for a human to manually document the model may be avoided.

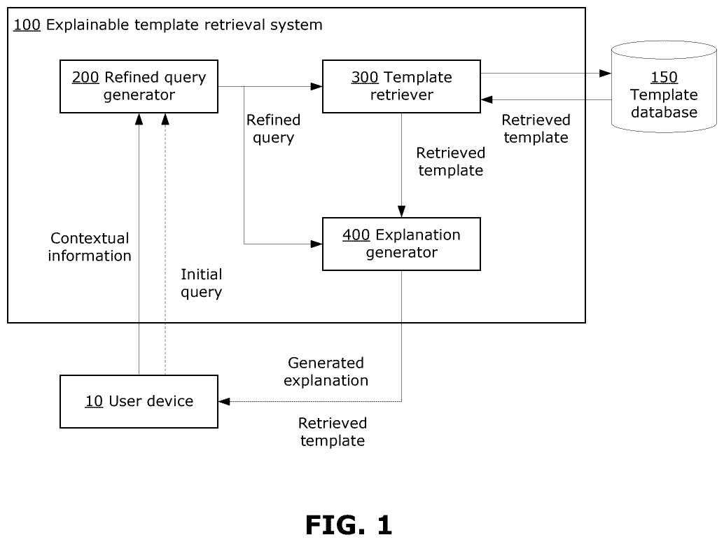

FIG. 1 is a schematic diagram illustrating an example explainable template retrieval system 100. The explainable template retrieval system 100 may be implemented in a single physical machine or device (e.g., implemented as a single computing device, such as a single workstation, single server, etc.), or may be implemented using a plurality of physical machines or devices (e.g., implemented as a server cluster). For example, the explainable template retrieval system 100 may be implemented as a virtual machine or a cloud-based service (e.g., implemented using a cloud computing platform providing a virtualized pool of computing resources). In some examples, the explainable template retrieval system 100 may provide cloud-based services accessible to a user device.

In this example, the explainable template retrieval system 100 is in communication (e.g., over a wired or wireless network) with a user device 10 and a template database 150. The template database 250 may be external to the explainable template retrieval system 100 (as shown) or may be part of the explainable template retrieval system 100. In some examples, the explainable template retrieval system 100 may also be in optional communication with a model storage (not shown) that may be a memory for storing an optimization model generated by the explainable template retrieval system 100. In some examples, the explainable template retrieval system 100 may cooperate with or be part of a model instantiation system (not shown) for instantiating the generated optimization model with data values, and the model instance may then be inputted to a solver (not shown) to solve the optimization problem.

In the example shown, the explainable template retrieval system 100 includes a refined query generator 200, a template retriever 300 and an explanation generator 400 as subsystems. It should be understood that, in some embodiments, the explainable template retrieval system 100 may have greater or fewer subsystems than that shown in FIG. 1. For example, operations described as being performed by a particular subsystem may be performed by a different subsystem of the explainable template retrieval system 100. In yet other examples, the explainable template retrieval system 100 may itself provide the functions of refined query generation, template retrieval and explanation generation, without having subsystems 200, 300 and 400. It should be understood that the explainable template retrieval system 100 may be implemented using various hardware and software, and is not intended to be limited to the example shown in FIG. 1.

Contextual information may be provided by the user via the user device 10. The contextual information may be a natural language problem specification that describes the optimization problem to be solved. An initial query may also optionally be provided by the user via the user device 10 or an initial query may be obtained from a stored database of structured model summaries (discussed further below). The initial query is a query for a particular template that will be used to generate an optimization model. The refined query generator 200 processes the contextual information to extract contextual information that is relevant to the initial query and adds the extracted contextual information to the initial query to generate a refined query. For example, the refined query generator 200 may generate a summary of the contextual information and append the summary to the initial query to generate the refined query. In another example, the refined query generator 200 may provide contextual information to clarify ambiguous text in the query. For example, if the query includes pronouns such as “it”, the refined query generator 200 may provide context to define that “it” refers to; or if the query includes a term such as “cost” that requires further definition, the refined query generator 200 may provide context to define such a term. In another example, the refined query generator 200 may extract keyword(s) from the contextual information and incorporate the extracted keyword(s) into the initial query (e.g., by concatenating the keyword(s) to the initial query) to generate the refined query.

For example, if an optimization problem is related to distribution of goods by a distribution company, the contextual information may include information about the number of drivers and trucks that the company has, preferences for working hours, physical limitations of the trucks, cost of gas, etc. The contextual information may be provided in a relatively long specification (e.g., a manual that is upwards of a hundred pages of text). This contextual information may be written in natural human language. If the contextual information was prepared by the user, the contextual information may contain relevant stylistic information of the user, level of expertise in OR, technical jargon, etc. The refined query generator 200 may perform operations to extract portions of the contextual information that are relevant to the optimization problem. Depending on the format of the contextual information, the extracted context may also take different forms. For example, extracted context may be in the form of an extracted sentence or textual segment. In other examples, extract context may be in the form of a list of keywords or a list of named tuples of metadata definition and values, among other possibilities.

In some examples, the initial query may be inputted by the user via the user device 10. The query may be inputted in natural language, and may lack sufficient context. For example, a user-provided initial query may be “I want my drivers to be more cost efficient”, which provides insufficient context for what impacts the “cost”. The refined query generator 200 may perform operations to extract, from the contextual information, the text section that is most relevant to the initial query (e.g., “The cost is related to drivers' travel time on the road, number of them working each day and the rate of overtime pay”) and concatenate (or add to the end) the initial query with the extracted contextual information to generate the refined query. For example, a generated refined query may be “I want to minimize the cost of drivers. The cost of drivers is related to drivers' travel time on the road, number of them working each day and the rate of overtime pay”.

In another example, an initial query may be obtained from a stored database of structured model summaries and may further be supplemented with information from the contextual information. For example, an initial query from the database of structured model summaries may be “What are some key measurements that you want to observe (maximize or minimize)?” and this may be further supplemented with “Based on your description, your goal is to decrease the overall cost of the operations”. Thus, information found in the contextual information may be appended to the initial query to provide a suggested query that the user may accept or reject (or modify). If the user accepts this initial query, then the refined query generator 200 may perform further operations to extract additional contextual information relevant to the “cost” in the initial query, similar to the example described above. The generated refined query may be “I want to “minimize cost of operations” defined by “drivers' travel time on the road, number of them working each day and the rate of overtime pay””.

The refined query generated by the refined query generator 200 is provided as input to the template retriever 300. The template retriever 300 uses the refined query to retrieve, from the template database 150, a retrieved template. The template database 150 may store a plurality of predefined templates related to model components that may be added to an optimization model. Each template stored in the template database 150 has some metadata associated with the template (e.g., metadata about the meaning of the template such as “minimize the total travel time”, “minimize the drivers wage”, etc.) and also symbolic content that is a mathematical representation of the template (e.g., Min sum (t_{ij . . . ), Min sum (f_{k} y_{k} . . . ), etc.). Each template thus has some information in the metadata that can be related to contextual information and also some information about the math content of the template, such as the dimensions. The metadata associated with each template is used to identify, from the template database 150, the most relevant template to the refined query. For example, consider the example refined query “I want to “minimize cost of operations” defined by “drivers' travel time on the road, number of them working each day and the rate of overtime pay””. The template database 150 may store, for example a template T1 having metadata “minimize the total travel time” and math content Min sum (t_{ij} x_{ij}); a template T2 having metadata “minimize the drivers wage” with math content Min sum (f_{k} y_{k}+c_{k} w_{k}); and a template T3 having metadata “minimize number of on-call drivers” with math content Min sum (y_{k}). The template retriever 300 uses the refined query to find the most relevant of the templates T1, T2, T3, and retrieves the retrieved template T1.

The retrieved template and refined query are then both inputted to the explanation generator 400 which generates a generated explanation, which may be outputted to be displayed via the user device 10. The generated explanation describes the relevance of the retrieved template to the initial query and the contextual information. The generated explanation uses the contextual information in the refined query to generate an explanation in accordance with the language and level of expertise indicated in the contextual information. This means the generated explanation may be tailored to the language and understanding of the user who provided the contextual information (rather than a generic explanation that is predefined for the template). This may enable the user to better understand the retrieved template and thus approve the retrieved template for use in generating the optimization model.

It may be noted that the explanation generator 400 generates an explanation from the refined query rather than a generic initial query. The refined query includes some of the contextual information provided by the user, enabling the explanation generator 400 to provide an explanation in the context of the user's problem. At the same time, using the refined query as input to the explanation generator 400 is preferable to using the entire original context specification which may be ambiguous, unstructured and/or long, and thus difficult to serve as a basis for explanation generation. For example, if the refined query is “I want to “minimize cost of operations” defined by “drivers' travel time on the road, number of them working each day and the rate of overtime pay”” and the retrieved template is T1 having metadata “minimize the total travel time”, the explanation generator 400 may extract the similarities between the refined query and the retrieved template to generate the explanation “You mention “minimize the cost of the operations” and the cost depends on “drivers' travel time”. Therefore, by minimizing the total travel time, the cost will be minimized”. This generated explanation may be provided to the user, via the user device 10.

Details of the subsystems 200, 300, 400 of the explainable template retrieval system 100 will be discussed further below, including example NLP language models that may be used to implement the subsystems 200, 300, 400 and example methods of training neural networks for the tasks of each subsystem 200, 300, 400. Briefly, trained NLP models (e.g., transformer models, including encoder-only transformer models such as a BERT model) may be used to encode contextual information, queries and/or templates into low-dimensional vectors (also referred to as embedding vectors or simply embeddings) and a comparison (e.g., computation of a cosine similarity metric) of the vectors may be performed to identify and retrieve a relevant template (i.e., a template that is relevant to the query, based on similarity of vectors) from the template database 150. The vectors described in the present disclose may, in some examples, be considered or referred to as embedding vectors. It should be understood that the term “vectors” as used herein may encompass “embedding vectors” or “embeddings”.

Explanation generation by the explanation generator 400 may be carried out in various ways. For example, the explanation generator 400 may use a trained NLP generative model (e.g., a trained encoder-decoder generative model such as a BART model) that is trained to perform an answering task where the refined query from the query refiner 200 is the knowledge base from which the explanation generator 400 draws context to answer the question “why is this template relevant”. In another example, the explanation generator 400 may use a trained model that is trained to perform a retrieval task where the contextual information is segmented into sentences or larger segments that may correspond to broader ideas and each textual segment may be treated a retrievable document. The retrieved template and each of these textual segments are converted to vectors using a NLP encoder (e.g., encoder-only transformer model such as BERT) and a similarity between the vectors (e.g., based on calculated cosine similarity metric) may be used to retrieve the most similar segment(s). The explanation generator 400 may then use a NLP generative model (e.g., an encoder-decoder transformer model, or any generative model such as BART, GPT-3, T5, etc.) to generate a natural language explanation using metadata from the retrieved template and the retrieved most relevant textual segment(s) from the refined query or contextual information. The input to the NLP generative model may be formatted in various ways. For example, metadata from the retrieved template metadata may be concatenated (e.g., separated by tags such as <QUERY>some text</QUERY><METADATA>some text</METADATA>), may be combined using a trained summarization model (which accepts the textual segments as input and generates a summary), or keywords may be extracted from the metadata and appended to the refined query, among other possibilities.

As previously mentioned, the explainable template retrieval system 100 may be implemented using different hardware configurations. An example computing system that may be used to implement the explainable template retrieval system 100 is now described.

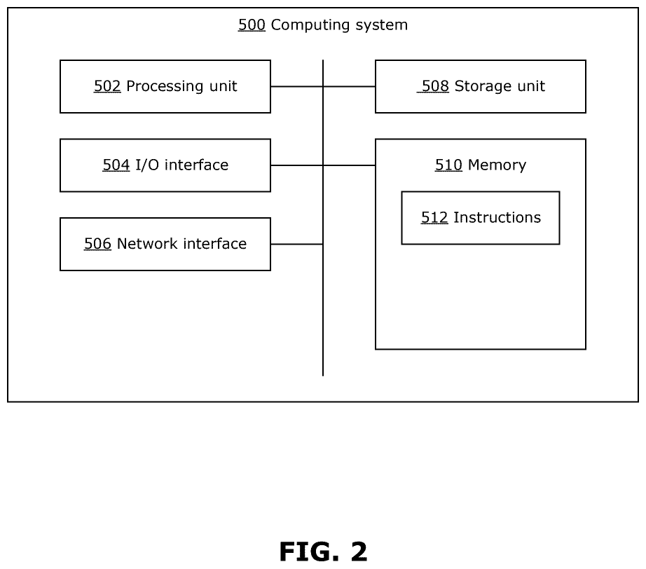

FIG. 2 is a block diagram illustrating a simplified example computing system 500 that may be used for implementing the explainable template retrieval system 100, in some embodiments. The computing system 500 may represent a server or a workstation, for example. As discussed previously, the explainable template retrieval system 100 may be implemented in other hardware configurations, including implementation using a plurality of computing systems. Although FIG. 2 shows a single instance of each component, there may be multiple instances of each component in the computing system 500. The computing system 500 may be used to execute instructions for training a neural network and/or for executing a trained neural network, as discussed further below.

In this example, the computing system 500 includes at least one processing unit 502, which may be a processor, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, combinations thereof, or other such hardware structure.

The computing system 500 may include an input/output (I/O) interface 504, which may enable interfacing with an input device and/or output device (not shown).

The computing system 500 may include a network interface 506 for wired or wireless communication with other computing systems (e.g., the template database 150, the user device 10, etc.). The network interface 506 may include wired links (e.g., Ethernet cable) and/or wireless links (e.g., one or more antennas) for intra-network and/or inter-network communications. The network interface 506 may also enable the computing system 500 to communicate outputs (e.g., generated explanations) to another computing system (e.g., to the user device 10).

The computing system 500 may include a storage unit 508, which may include a mass storage unit such as a solid state drive, a hard disk drive, a magnetic disk drive and/or an optical disk drive.

The computing system 500 may include a memory 510, which may include a volatile or non-volatile memory (e.g., a flash memory, a random access memory (RAM), and/or a read-only memory (ROM)). The non-transitory memory 510 may store instructions for execution by the processing unit 502, such as to carry out example embodiments described in the present disclosure. For example, the memory 510 may store instructions 512 for implementing the explainable template retrieval system 100 as well as any of the methods disclosed herein. The memory 510 may also store neural network parameters, which may be parameters learned from training a neural network, such as learned parameters of neural networks implemented in the explainable template retrieval system 100. The memory 510 may include other software instructions, such as for implementing an operating system and other applications/functions.

The computing system 500 may additionally or alternatively execute instructions from an external memory (e.g., an external drive in wired or wireless communication with the server) or may be provided executable instructions by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

Reference is again made to FIG. 1. The explainable template retrieval system 100 may be used, as part of an optimization modeling system and/or together with a solver, to enable modeling of an optimization problem and solving of the optimization problem. In examples discussed further below, an incremental modeling approach is described in which an optimization model may be built through retrieval of templates and generation of explanations for each retrieved template to explain relevance. In this way, the process of generating an optimization model (and thus solving the optimization problem) may be made more efficient and the need for human input (e.g., by an OR expert) may be reduced.

Details of the refined query generator 200 are first discussed.

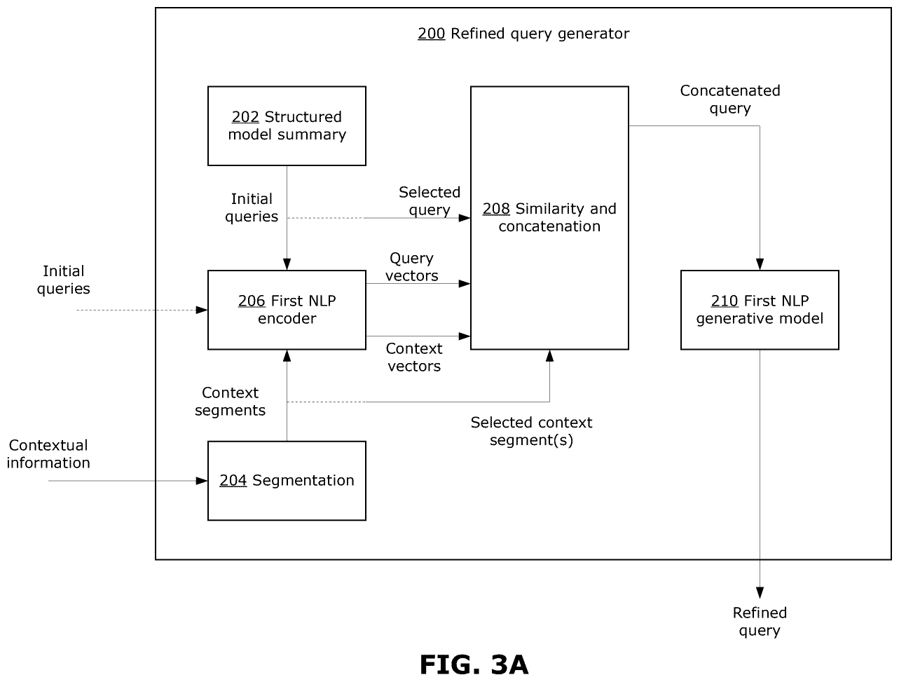

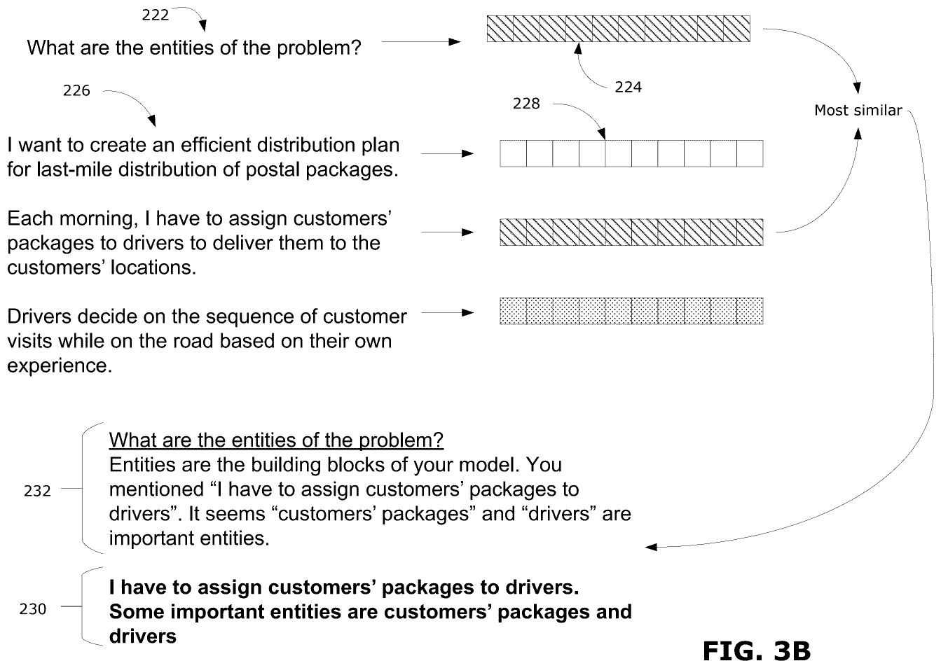

FIG. 3A is a block diagram illustrating an example implementation of the refined query generator 200. Although the refined query generator 200 is illustrated with certain functional blocks, it should be understood that this is not intended to be limiting.

The refined query generator 200 may access a structured model summary 202, which is a data structure that may be used to track the components required to retrieve a base model template and generate the optimization model. The structured model summary 202 is shown in FIG. 3A as being implemented in the refined query generator 200, however in other examples the structured model summary 202 may be external to the refined query generator 200. For example, the structured model summary 202 may be a data structure stored in the overall explainable template retrieval system 100. The structured model summary 202 may be initially empty. For example, the structured model summary 202 may require information to identify entities of the model, a main key performance indicator (KPI) or optimization target, and any contextual rules (e.g., business rules and other constraints). The refined query generator 200 may define initial queries (which may be predefined natural language questions) that relate to the information required to complete the structured model summary 202, such as “What are the entities of the problem?”, “What is a main KPI you want to include?”, and “What is a business rule?” In some examples, a user may input an initial query (which may be a natural language query) via the user device 10.

The refined query generator 200 may also include a segmentation module 204 that segments the contextual information (which may be provided by the user device 10 as a single long text document) into context segments (e.g., sentences). It may be expected that, in many or most cases, the contextual information may be too long to be processed in its entirety. For example, the contextual information may be provided as a text document that is hundreds of pages long, containing thousands or tens of thousands of sentences. In such cases, the contextual information may be processed a portion at a time (e.g., using a moving window). The segmentation module 204 may thus generate context segments that correspond to a portion of the contextual information (rather than the entirety of the contextual information).

The refined query generator 200 uses a trained first NLP encoder 206 (e.g., a trained encoder-only transformer, such as a BERT model) that has been trained to encode context segments and initial queries into a common vector space. In particular, the first NLP encoder 206 has been trained (discussed in greater detail below) such that a context segment and an initial query that are relevant to each other are encoded in to a respective context vector and query vector that are close to each other in the vector space. Using the first NLP encoder 206, the initial queries (e.g., predefined initial queries or inputted by the user) are encoded into corresponding query vectors. In some examples, if the initial queries are predefined, the corresponding query vectors may be generated using the first NLP encoder 206 beforehand and stored by the refined query generator 200, such that the query vectors may not need to be generated each time. Doing so may help to decrease the runtime computations required and may help to achieve real-time execution of the explainable template retrieval system 100 (e.g., the user is able to interact with the explainable template retrieval system 100 and receive output from the explainable template retrieval system 100 with little or no latency). As well, the first NLP encoder 206 is used to encode the context segments into context vectors.

The query vectors and context vectors are inputted into a similarity and concatenation module 208 that compares each query vector to each context vector to identify query-context vector pairs that are most similar. It should be noted that, because the context segments may correspond to only a portion of the contextual information (e.g., in the case where the original contextual information is too long to be processed in its entirety), the context segments may or may not contain context relevant to each initial query. Thus, the similarity and concatenation module 208 may perform operations to ensure that only query-context vector pairs that meet a minimum similarity threshold are identified.

For example, the similarity and concatenation module 208 may compute a similarity metric (e.g., a cosine similarity) between each query vector and each context vector (that is, if there are n query vectors and m context vectors, n×m similarity metrics are computed). Then the query-context vector pair(s) having a similarity metric that exceeds a predefined similarity threshold (e.g., at least 70% similarity) are identified as matched pair(s) (where the query vector and the context vector in a matched pair may be referred to as matching each other). Based on the matched pair(s), the similarity and concatenation module 208 may select the query corresponding to the query vector having the highest number of matching context vector(s). Then the context segment(s) corresponding to the context vector(s) matching the query vector of the selected query are also selected. The similarity and concatenation module 208 concatenates the selected query with the selected context segment(s) to generate a concatenated query. The concatenated query may include tags identifying the query and the context segment(s).

The concatenated query is inputted to a first NLP generative model 210 (e.g., an encoder-decoder transformer model, such as a BART model). The first NLP generator model 210 is trained to generate a natural language refined query from the concatenated query. The refined query may then be passed to the template retriever 300.

In some examples, the process of generating the refined query may include presenting (e.g., via a user interface (UI) on the user device 10) to the user the refined query for the user to approve, reject or modify. The refined query may be passed to the template retriever 300 after approval by the user. In cases where a user is able to approve the refined query, presentation of the refined query may be augmented with presentation of the initial query along with predefined metadata explaining the initial query and the extracted context information, to enable the user to understand the refined query.

For example, a portion of the contextual information may be “I want to serve all customers, have a balanced workload among drivers to prevent overtime, and decrease the overall cost of the operations.” The initial query may be a predefined question related to the structured model summary 202 such as “What are some key measurements that you want to observe (maximize or minimize)?” The initial query may be obtained from a list of predefined generic questions that correspond to different requirements for completing the structured model summary 202. These questions may be designed to prompt the user to verify information such as the objective, whether time is a dimension, the entities of the problem, the problem type, etc. It should be noted that even if the initial query is selected from a list of predefined questions, the order in which such questions are presented may not be predetermined. Using the operations of the refined query generator 200 described above, the generated refined query may be “What are some key measurements that you want to observe (maximize or minimize)? Based on your description, your goal was to “decrease the overall cost of the operations”. Do you want to “minimize cost of operations” defined by “drivers' travel time on the road, number of them working each day and the overtime pay”?” In this example, a potential objective “decrease the overall cost of operations” was identified in the contextual information along with the factors that impact “cost”. The user may accept, revise, or reject the refined query.

FIG. 3B illustrates another example of a refined query that may be generated using the refined query generator 200.

In this example, only one initial query 222 is shown, which may be a predefined question that is designed to collect required information for completing the entities of the structured model summary 202. The initial query 222 is encoded (by the first NLP encoder 206) into a query vector 224. Three context segments 226 are shown (which may be segmented from a longer document containing contextual information), each of which is encoded (by the first NLP encoder 206) into a respective context vector 228. A query-context vector pair having highest similarity (as represented by similar shading in FIG. 3B) is identified and concatenated (e.g., by the similarity and concatenation module 208), and inputted to the first NLP generator model 210 to generate the refined query 230. In this example, the refined query 230 is presented on the user device 10 for user approval. The refined query 230 is presented together with additional information 232 such as the initial query, a generic explanation of the initial query and extracted contextual information. The user may approve, reject or modify (e.g., edit the text) the refined query. The approved refined query may then be passed to the template retriever 300.

The refined query generator 200 in the explainable template retrieval system 100 performs operations that enable contextual information found in the problem specification to be extracted and added to the initial query to form the refined query. It may be noted that using the NLP-based approach as described above enables the context relevant to a query to be extracted in order to form the refined query. This may be advantageous over other approaches such as concatenating the problem specification with the initial query, because the problem specification may be exceedingly long and/or may contain irrelevant or ambiguous information that may hamper template retrieval. By using the refined query generator 200 as described above, only context that is relevant to the initial query may be extracted, thus generating a refined query that is relatively concise while also containing information-rich context. The refined query, by including information about the context, may help to improve the performance of the template retriever 300 and explanation generator 400. The refined query may optionally be presented to the user for review, revision and approval.

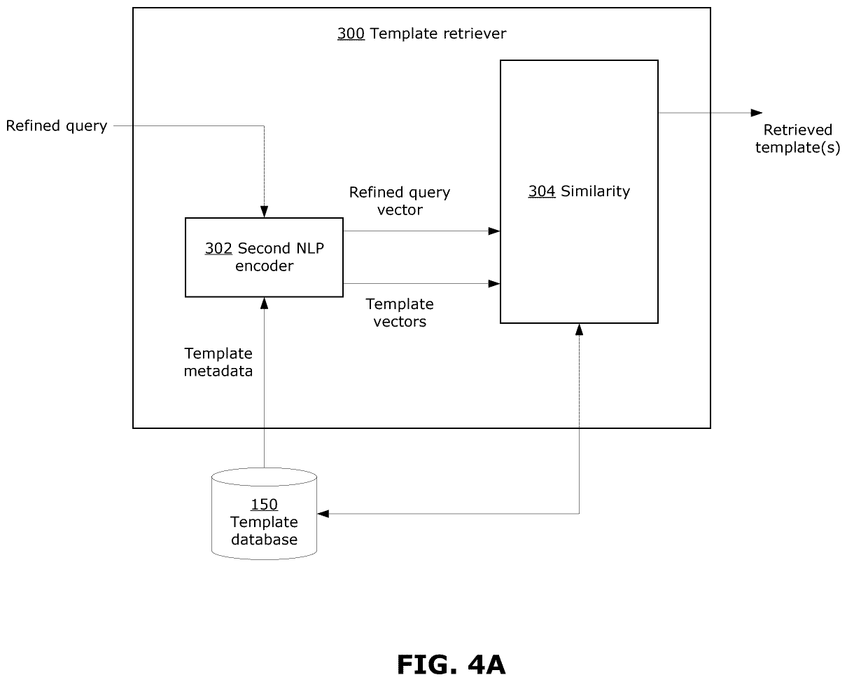

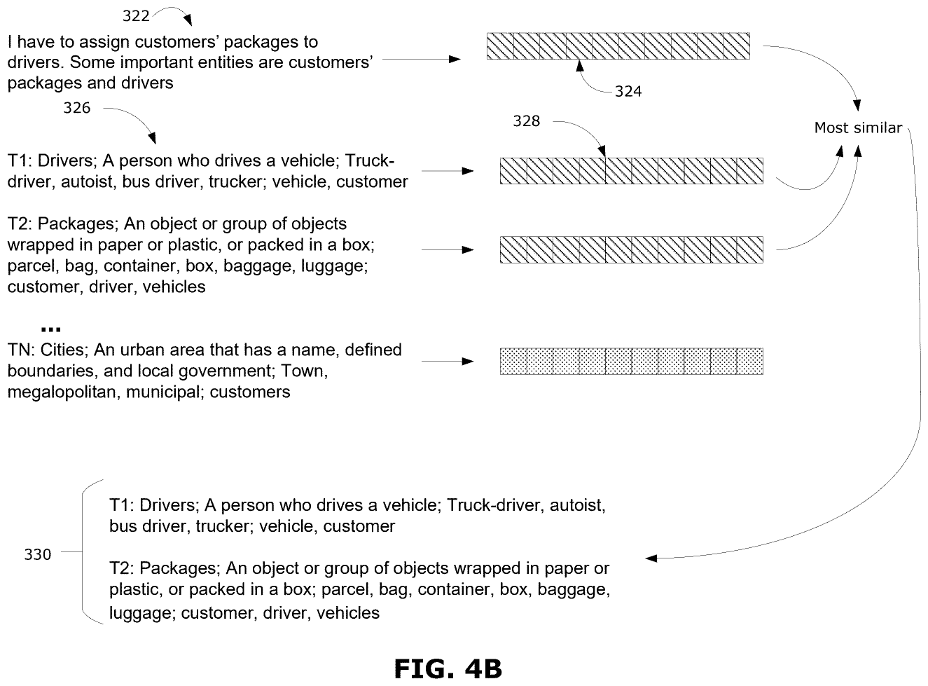

FIG. 4A is a block diagram illustrating an example implementation of the template retriever 300. Although the template retriever 300 is illustrated with certain functional blocks, it should be understood that this is not intended to be limiting.

The template retriever 300 receives the refined query (which may have been approved by the user). The template retriever 300 also has access to or include the template database 150 (FIG. 4A illustrates the template database 150 being external to the template retriever 300, but in some examples the template database 150 may be part of the template retriever 300). The templates stored in the template database 150 are each associated with metadata (e.g., semantic information such as a generic explanation of the template) and some symbolic content (e.g., math content).

The refined query is encoded into a refined query vector by a trained second NLP encoder 302 (e.g., a trained encoder-only transformer, such as a BERT model). As well, semantic metadata associated with each template is encoded into template vectors by the second NLP encoder 302. The second NLP encoder 302 has been trained to encode the refined query and template metadata into vectors in a common vector space. In particular, the second NLP encoder 302 has been trained (discussed in greater detail below) such that a refined query and template metadata that are relevant to each other are encoded in to a respective refined query vector and template vector that are close to each other in the vector space. In some examples, the template metadata may be encoded into corresponding template vectors using the second NLP encoder 302 beforehand and stored (e.g., stored in association with the corresponding template in the template database 150, or stored by the template retriever 300), such that the template vectors may not need to be generated each time. Doing so may help to decrease the runtime computations required and may help to achieve real-time execution of the explainable template retrieval system 100 (e.g., the user is able to interact with the explainable template retrieval system 100 and receive output from the explainable template retrieval system 100 with little or no latency).

The refined query vector and template vectors are inputted into a similarity module 304. The similarity module 304 computes a similarity metric (e.g., cosine similarity) between the refined query vector and each template vector. The similarity module 304 may identify the template vector(s) that are sufficiently similar to the query vector (e.g., having similarity metric exceeding a predefined threshold, for example at least 70%) and/or may identify the top few (e.g., top three) most similar template vectors. The template(s) corresponding to the identified template vector(s) may be retrieved from the template database 150. The retrieved template(s) may then be passed to the explanation generator 400. In some examples, the template retriever 300 may also pass the refined query (which the template retriever 300 received from the refined query generator 200) to the explanation generator 400; in other examples, the explanation generator 400 may receive the refined query from the refined query generator 200 instead.

Consider an example where the refined query is “I want to “minimize cost of operations” defined by “drivers' travel time on the road, number of them working each day and the rate of overtime pay””. The second NLP encoder 302 may process this refined query as input and generate the corresponding refined query vector. If the template database 150 stores a template T1 having metadata “minimize the total travel time”; a template T2 having metadata “minimize the drivers cost”; and a template T3 having metadata “maximize vehicle use”, the second NLP encoder 302 may process the metadata of each of the templates T1, T2 and T3 as respective inputs and generate respective template vectors. The similarity module 304 may compute the similarity metric (e.g., cosine similarity) between the refined query vector and each of these template vectors, and identify the template vector corresponding to template T2 as being most similar to the refined query vector. Thus, the template T2 having metadata “minimize the drivers cost” (and additional math content) is retrieved from the template database 150.

In some examples, more than one template may be retrieved. For example, if the refined query is related to entities, the query may include multiple entities that require multiple templates to be retrieved. An example of this is shown in FIG. 4B.

A refined query 322 is shown, which may have been generated by the refined query generator 200 and passed to the template retriever 300. The refined query 322 is encoded (by the second NLP encoder 302) into a refined query vector 324. In this example, there may be N templates 326 stored in the template database 150, each template having metadata that provides a generic meaning of each template 326. In this example, template T1 is a template for the entity “Drivers”, and includes metadata defining the meaning of the template (“A person who drives a vehicle”), synonyms (“Truck-driver, autoist, bus driver, trucker”), and related entities (“vehicle, customer”). The metadata may include tags indicating the types of information in the metadata. For example, the metadata for an entity template may include a [NAME] tag to indicate the name of the entity, a [VARIANTS] tag to indicate variants or synonyms of the entity and/or a [COMMON_ENTITIES] tag to indicate related entities. For example, the metadata for T1 may have the following form:
[CLS] [NAME] Drivers [VARIANTS] Truck-driver, autoist, bus driver, trucker [COMMON_ENTITIES] vehicle, customer [SEP]
   where the tag [CLS] indicates the start of the text in the metadata and [SEP] indicates the end. It should be noted that, in some examples, tags may not be required and instead the metadata may have a defined format or defined fields.

Template T2 is a template for the entity “Packages”, and template TN is a template for the entity “Cities”; each template 326 includes similar types of metadata. The metadata of each template 326 is encoded (by the second NLP encoder 302) into a respective template vector 328. There are two template vectors 328 that are found (e.g., by the similarity module 304) to have sufficient similarity with the refined query vector 324 (as represented by similar shading in FIG. 4B). Thus, T1 and T2 are the retrieved templates 330 retrieved from the template database 150. The retrieved templates 330 may be passed to the explanation generator 400.

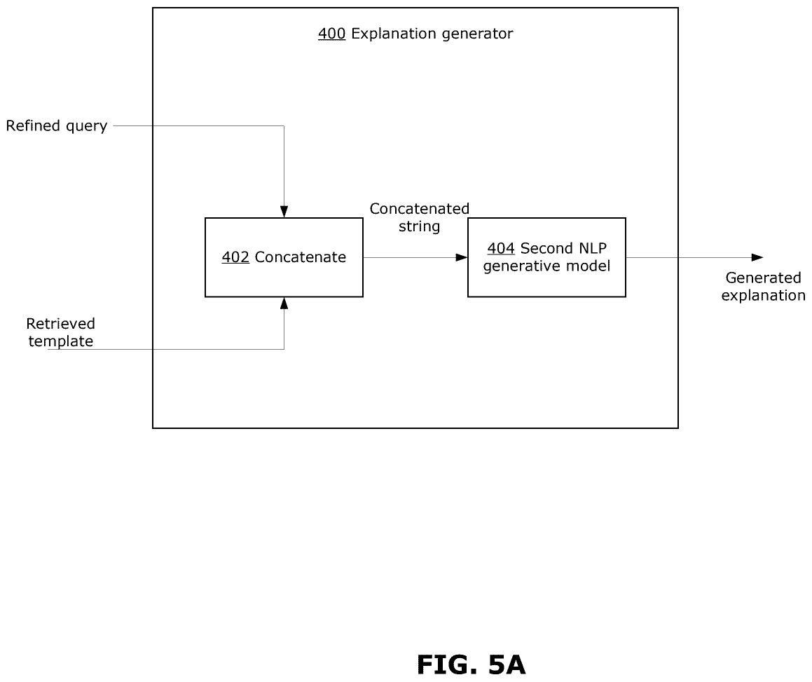

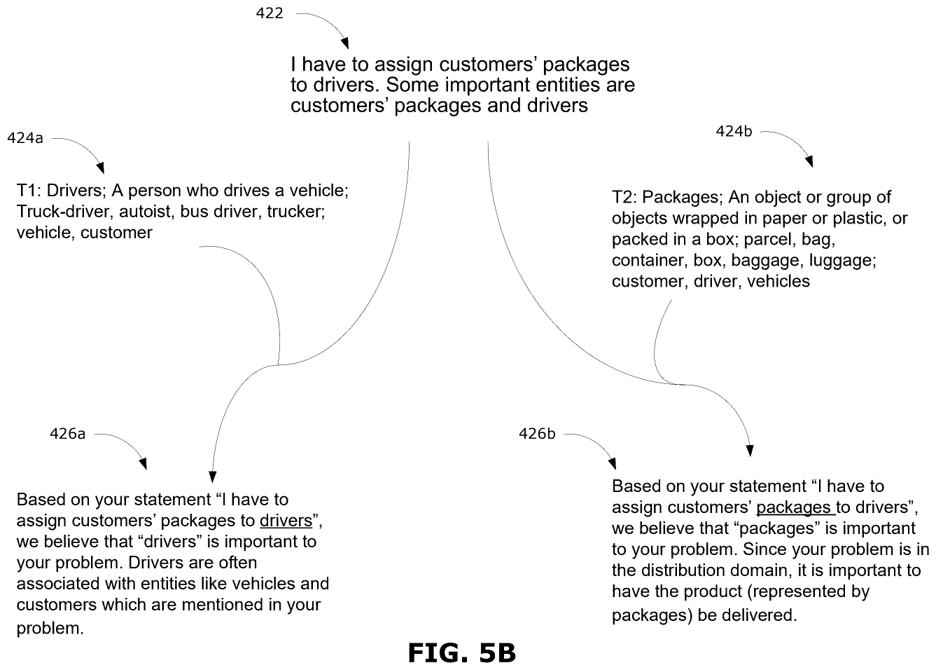

FIG. 5A is a block diagram illustrating an example implementation of the explanation generator 400. Although the explanation generator 400 is illustrated with certain functional blocks, it should be understood that this is not intended to be limiting.

The explanation generator 400 receives the refined query and the retrieved template. It may be noted that if there are multiple retrieved templates retrieved by the template retriever 300, the explanation generator 400 may process the retrieved templates one by one to generate respective generated explanations.

The refined query and the metadata of the retrieved template may be concatenated together by a concatenation module 402 into a concatenated string. The concatenation module 402 may optionally add tags to indicate the start and/or end of the query and the start and/or end of the template metadata within the concatenated string.

The concatenated string is inputted to a second NLP generative model 404 of the explanation generator 400. The second NLP generative model 404 may be, for example, an encoder-decoder transformer model (e.g., a BART model) that has been trained to generate a natural language explanation from the concatenated refined query and the template metadata.

For example, if the refined query is “I want to “minimize cost of operations” defined by “drivers' travel time on the road, number of them working each day and the rate of overtime pay”” and the template metadata is “minimize the total travel time”, then the concatenated string may be “[QUERY] I want to “minimize cost of operations” defined by “drivers' travel time on the road, number of them working each day and the rate of overtime pay” [TEMPLATE] minimize the total travel time”. This may be processed by the second NLP generator mode 404 to generate the generated explanation “You mentioned “minimize the cost of operations” and the cost depends on “drivers' travel time”. Therefore, by minimizing the total travel time, the cost will be minimized.” Thus, the explanation generator 400 draws on contextual information contained in the refined query and the similarities found in the template metadata to provide a generated explanation that explains the template using language suiting the specific context (e.g., including technical level, user style, problem domain, etc.) of the problem.

The generated explanation may then be outputted, for example to be presented to the user via the user device 10 (e.g., via a UI, as discussed further below). The generated explanation may be displayed together with the retrieved template and/or the refined query. In some examples, metadata from the retrieved template may (after user approval if applicable) be appended to the contextual information to update the contextual information. The updated contextual information may be used for generating subsequent refined queries.

If there are multiple retrieved templates, the explanation generator 400 may generate multiple generated explanations and each generated explanation may be presented together with the respective retrieved template. FIG. 5B illustrates an example where there are multiple generated explanations for the refined query.

In this example, the refined query 422 and metadata 424a, 424b from two templates are provided to the explanation generator 400. The refined query 422 is concatenated with the first metadata 424a, then is processed (e.g., by the second NLP generative model 404) to generate a first generated explanation 426a. The refined query 422 is then concatenated with the second metadata 424b, then processed to generate a second generated explanation 426b.

Each of the generated explanations 426a, 426b may be presented together with the respective retrieved template for a user to approve, reject or modify for example. If the user approves a template, the structured model summary may be populated with the data (e.g., symbolic math content and optionally metadata) of the approved template.

Some examples of how to train the NLP models of the explainable template retrieval system 100 (e.g., the first NLP encoder 206, the first NLP generative model 210, the second NLP encoder 302 and the second NLP generative model 404) are now described.

Each of the first and second NLP encoder 206, 302 may, in some examples, be an encoder-only transformer, such as a BERT model, that may be fine-tuned on data over multiple domains (e.g., corresponding to different business domains, such as distribution, that are commonly relevant to optimization problems).

The first NLP encoder 206 may be fine-tuned using a training dataset that pairs a context segment (e.g., a sentence from a natural language context description) with a natural language query for a matching model component. The context segment and the paired query are both processed by the first NLP encoder 206 to generate a context vector and query vector, respectively. Then the similarity metric (e.g., cosine similarity) between the two vectors are computed. The goal of the training may be to maximize similarity between the two vectors, for example the computed similarity metric may be used to update (e.g., using a back propagation algorithm) the parameters of a task-specific layer of the first NLP encoder 206.

The second NLP encoder 302 may be fine-tuned using a training dataset that pairs a natural language refined query with tagged metadata for a model component template that satisfies the refined query. For example, a refined query “We have access to 5 trucks, 10 drivers and the staff and drivers work from Monday to Saturday 6 am to 6 pm” may be paired with tagged metadata for a model entity template related to vehicles such as: [CLS] [NAME] vehicles [VARIANTS] truck, van, car, SUV, wagon, cart, ship, boat, train, rail, lorry, taxi, airplane, bike, scooter, e-bike [COMMON_ENTITIES] drivers, depots, packages, customers [SEP]. The training dataset may include such pairs of data for different types of model components (e.g., including different entities, different decisions, different objectives, different constraints, etc.) and for different domains. The refined query and the paired metadata are both processed by the second NLP encoder 302 to generate a refined query vector and template vector, respectively. Then the similarity metric (e.g., cosine similarity) between the two vectors are computed. The goal of the training may be to maximize similarity between the two vectors, for example the computed similarity metric may be used to update (e.g., using a back propagation algorithm) the parameters of a task-specific layer of the second NLP encoder 302.

The first and second NLP generative models 210, 404 may, in some examples each be a respective encoder-decoder transformer, such as a BART model, that may be trained to perform a sequence-to-sequence text generation task. The encoder-decoder transformer may be fine-tuned to generate a refined query or an explanation.

For example, the first NLP generative model 210 may be fine-tuned using a training dataset containing data triplets, where each triplet contains an initial query, a relevant context segment and the refined query that should be generated. The refined query in each data triplet may be manually created or may be created in a semi-automatic manner (e.g., generated in a rough form by software and further edited by a human).

In a similar manner, the second NLP generative model 210 may be fine-tuned using a training dataset of data triplets where each triple contains template metadata, a relevant refined query and the context-based explanation that should be generated. The context-based explanation in each data triplet may be manually created or semi-automatically created.

The explainable template retrieval system 100, as described above, performs operations to provide retrieved templates together with context-grounded explanations. This may provide information to enable a user to select or approve a template that can then be used to generate the optimization model. Retrieval of relevant templates also benefit from the inclusion of context in a refined query. Because there is more information included in the refined query, compared to a generic query, a more suitable or more appropriate template may be retrieved. Since templates are used as building blocks for generating the optimization model, improving the template retrieval may also help to improve the optimization model generation.

The generated explanation takes into account stylistic information (e.g., the level of understanding of English, use of technical language specific to the application domain, etc.) as well as problem context and/or OR level of expertise represented in the contextual information, thus helping to ensure that the generated explanation is understandable to the user.

The explainable template retrieval system 100 may provide a user with greater understanding and control over the process of generating an optimization model, without requiring the user to be an OR expert. The explainable template retrieval system 100 may be used throughout different stages of generating an optimization model, and for retrieval of different templates. For example, the explainable template retrieval system 100 may be used to retrieve an entire model, a base model and/or individual components of an optimization model (e.g., constraints, objectives, metrics, entities, etc.). An example of how the explainable template retrieval system 100 may be used in an incremental modeling method to generate an optimization model is now described.

The explainable template retrieval system 100 may be used throughout different stages of the incremental modeling method to retrieve templates and provide explanations about the relevance of the templates to the optimization problem. This process may replace the need for a human OR expert and may enable a non-OR user to generate an optimization model, without requiring any knowledge of coding.

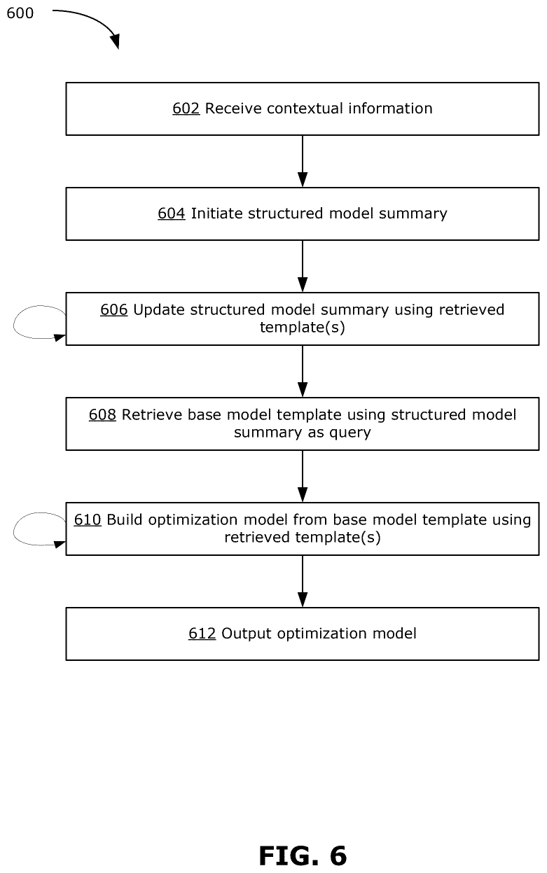

FIG. 6 is a flowchart of an example incremental modeling method 600, which may be performed using a computing system (e.g., as shown in FIG. 2) implementing an example of the disclosed explainable template retrieval system 100. The incremental modeling method 600 may, in some examples, be implemented using other computing systems and may not necessarily be limited to the explainable template retrieval system 100. The incremental modeling method 600 may be performed by a computing system implementing an incremental modeling system (which may or may not be based on or include the explainable template retrieval system 100).

It should be noted that user interaction with the explainable template retrieval system 100 may be supported at each or any step of the incremental modeling method 600. As will be discussed further below, in some examples user interactions (e.g., receiving user inputs and/or providing user outputs) may be via a UI provided by a computing system (e.g., the computing system that also implements the explainable template retrieval system 100).

At 602, contextual information is received. For example, contextual information may be reviewed from a user via a user device 10 in communication with the computing system (e.g., over a wireless network). The contextual information contains at least a textual description of the optimization problem to be modeled, which may be described using natural language. The contextual information may be provided to the system by, for example, the user uploading a text document containing the problem specification. The contextual information may be any natural language text with no requirement of structure or content. The contextual information may describe the context of the optimization problem, in any level of detail and any level of technicality, for example according to the knowledge of the user.

At 604, a structured model summary may be initiated. The structured model summary may be a data structure having some default data fields. The structured model summary may provide a structure for storing information about the model components (e.g., entities, constraint(s), objective(s), etc.) that are required to properly describe the optimization problem. In some examples, this step may be omitted.

At 606, the structured model summary is updated using one or more retrieved templates, which may be retrieved from a template database (e.g., the template database 150). Each template is related to a respective model component. Each template may be retrieved using a respective refined query, which is generated from the contextual information and contains context (which may assist in retrieving a relevant template). The refined query may be a natural language query that incorporates natural language text from the contextual information and that also contains information related to the model component to be retrieved. The refined query may be presented to a user (e.g., via the user device 10) to review, edit and/or approve prior to retrieving the template using the refined query. In some examples, the refined query may be presented to the user only when the refined query is related to a more complex model components such as decisions and constraints, and may not be presented to the user when the refined query is related to simpler model components such as entities In some examples, whether or what type of refined queries should be presented to the user to review edit and/or approve may be a user-configurable option. In some examples, the contextual information may also be updated using metadata from the retrieved templates. For each retrieved template, a context-grounded explanation may be generated and presented to the user, to enable the user to review and approve (or reject) the retrieved template for use in the structured model summary.

Step 606 may be iterative (as indicated by the use of a curved arrow), such that the structured model summary is updated incrementally (e.g., by retrieving templates for different model components until all required fields of the structured model summary has been updated with information from retrieved templates).

For example, an iteration of step 606 may involve obtaining an initial query (e.g., from user input or from a predefined list of queries related to the structured model summary) that is refined into a refined query. Optionally, the refined query may be presented for user review and approval. The refined query may then be used to retrieve a model specification template (e.g., a template for a model entity or a model objective). A context-grounded explanation may be generated to relate the retrieved template to the contextual information, which may be presented to the user for approval. After the template has been retrieved (and optionally approved by the user), the metadata associated with the template (which may be a natural language description of the template) may be used to update the contextual information (e.g., the metadata of the template may be appended to the contextual information) and the template may be used to update the structured model summary. In some examples, the instead of or in addition to updating the contextual information with the template metadata, the contextual information may be updated with the context-grounded explanation that was generated.

At 608, a base model template is retrieved using the structured model summary (which has been updated in step 606) as a query. The structured model summary may be used to query a template database (e.g., the template database 150) in which the base model template is stored. The symbolic base model associated with the base model template is also retrieved. The symbolic base model may serve as the basis for building the final symbolic model that will be the optimization model. The symbolic model contains symbolic content that is free of context and which may be difficult to be understood by a non-OR expert. Thus, step 608 may include generating a context-grounded explanation to relate the base model template to the structured model summary. The context-grounded explanation may be presented to a user (e.g., via the user device 10) to review and/or approve. In some examples, if there are multiple base model templates that are retrieved (e.g., multiple base model templates are found to match the structured model summary), the context-grounded explanations for all retrieved base model templates may be presented and a user selection of one base model template may be received.

At 610, the optimization model is built from the base model template using one or more retrieved templates. That is, the base model template may be used as the starting point for the optimization model, and additional retrieved template(s) may incrementally build the optimization model. For example, constraints and/or objectives may be added to build the optimization model from the starting point (i.e., the base model template) into a more complex optimization model that better represents the optimization problem. One or more templates for one or more additional model components to be added to the optimization model are retrieved (e.g., from the template database 150), and are used to update the symbolic model associated with the optimization model. Each template for an additional model component may be retrieved using a respective refined query. For example, the retrieved base model template may predefine an additional template that may be added to the optimization model. Thus an initial query (related to the predefined templates) may be predefined based on the base model template and the refined query may be generated based on the initial query. In another example, if the base model template does not include a template that was included in the structured model summary, then the metadata for that omitted template may be used as a refined query to add that template to the optimization model. In another example, the refined query may be generated based on a user-inputted initial query. Similar to step 606, the refined query may be presented to the user (e.g., via the user device 10) to review, edit and/or approve prior to using the refined query to retrieve a template. Optionally, the user may be provided with each retrieved template with context-grounded explanation, to enable the user to approve the retrieved template. Step 610 may be iterative (as indicated by the use of a curved arrow), such that the symbolic model is updated incrementally (e.g., by retrieving templates for different symbolic components to add to the symbolic model (optionally with user approval) until a final symbolic model has been generated).

At 612, the final optimization model and associated symbolic model that results from one or more iterations of step 610 is outputted as the generated optimization model. The optimization model may be stored for future use and/or may be instantiated with data values into a model instance that may then be solved by a solver.

It should be understood that although the incremental modeling method 600 is described as a method or process, the incremental modeling method 600 as disclosed herein may be embodied as a system. For example, a computer-implemented incremental modeling system (which may be an embodiment of the computing system of FIG. 2) may execute instructions to implement the incremental modeling method 600. Additionally, one or more steps of the incremental modeling method 600 may be carried out by executing instructions of a subsystem or software module of the incremental modeling system. For example, step 606 may represent operations of a structured model summary clarifier subsystem of the incremental modeling system; step 608 may represent operations of a base model template retriever and explainer subsystem of the incremental modeling system; and step 610 may represent operations of a model builder subsystem of the incremental modeling system.

Further, one or more steps of the incremental modeling method 600 may be performed using the explainable template retrieval system 100. For example, the explainable template retrieval system 100 may be used to retrieve templates for updating the structured model summary and contextual information at step 606, the explainable template retrieval system 100 may be used to retrieve base model templates and generate template explanations at step 608, and the explainable template retrieval system 100 may be used to retrieve templates for additional model components for building the optimization model at step 610.

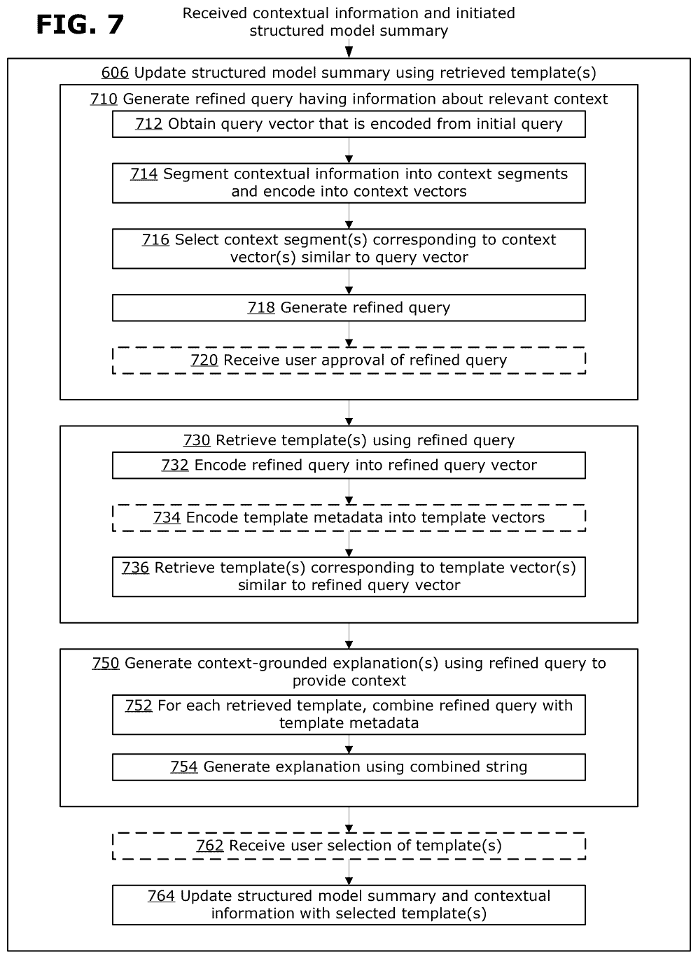

FIG. 7 illustrates details of example steps for performing step 606. The steps illustrated in FIG. 7 may be performed using the explainable template retrieval system 100, as discussed further below.

Prior to step 606, the contextual information is received and the structured model summary is initiated. Step 606 may be performed using steps 710, 730 and 750, each of which may include sub-steps as discussed below.

At 710, a refined query is generated. The refined query contains information about the relevant context, which may be extracted from the contextual information using trained NLP models. Step 710 may be performed using the refined query generator 200. In some examples, performing step 710 may involve performing steps 712-720.

At 712, a query vector is obtained. The query vector is obtained by encoding an initial query (which may be received from user input via the user device 10 or from a predefined list of queries). The initial query is encoded into a query vector using a trained NLP encoder (e.g., using the first NLP encoder 206 of the refined query generator 200). If the initial query is from a predefined list of queries, the initial query may be presented to the user for the user's review and/or approval. If the initial query is from a predefined list of queries, the query vector may have been generated using the trained NLP encoder and stored in memory prior to the incremental modeling method 600; the query vector may then be obtained at step 712 by retrieving the query vector from memory. In this example, there is one initial query and one corresponding query vector. In other examples, there may be multiple initial queries (and multiple corresponding query vectors).

At 714, the contextual information is segmented into context segments (e.g., using the segmentation module 204 of the refined query generator 200) and the context segments are encoded into context vectors using a trained NLP encoder (e.g., using the first NLP encoder 206 of the refined query generator 200).

At 716, based on similarity between the query vector and each context vector, one or more context segments are selected corresponding to one or more context vectors that are similar to the query vector. For example, the similarity and concatenation module 208 of the refined query generator 200 may be used to compute similarity metrics (e.g., cosine similarity) and identify the context vector(s) that are sufficiently similar to the query vector. The context segment(s) corresponding to the identified context vector(s) may then be selected.

At 718, a refined query is generated. For example, the selected context segment(s) may be combined (e.g., concatenated) with the initial query. The combined string may be provided as input to a trained NLP generative model (e.g., the first NLP generative model 210 of the refined query generator 200) and a refined query is obtained. In this example, one refined query is generated. In other examples, there may be multiple refined queries generated (e.g., corresponding to multiple selected context segments).

Optionally, at 720, user approval of the refined query may be received. For example, the generated refined query may be presented (e.g., via a UI on a user device 10) to the user to accept, reject or modify.

At 730, one or more templates are retrieved. The template(s) may be retrieved by using the refined query generated from step 720. A trained NLP model may be used for performing the template retrieval. Step 730 may be performed using the template retriever 300. Performing step 730 may include performing steps 732-736, for example.

At 732, the refined query (optionally after user approval and/or modification) is encoded into a refined query vector using a trained NLP encoder (e.g., using the second NLP encoder 302 of the template retriever 300).

Optionally, at 734, template metadata associated with templates stored in a template database may be encoded into respective template vectors using a trained NLP encoder (e.g., using the second NLP encoder 302 of the template retriever 300). In some examples, the template metadata may have been encoded into template vectors prior to the incremental modeling method 600 and stored in memory (e.g., in the template database 150); then, step 734 may be omitted and the previously generated template vectors may be obtained from the memory.

At 736, based on similarity between the refined query vector and each template vector (whether obtained from the memory or obtained by performing step 734), one or more templates are retrieved corresponding to one or more template vectors that are similar to the refined query vector. For example, the similarity module 304 of the template retriever 300 may be used to compute similarity metrics (e.g., cosine similarity) and identify the template vector(s) that are sufficiently similar to the refined query vector. For example, the template vector(s) that have similarity metrics exceeding a minimum similarity (e.g., at least 70% similarity) may be identified and/or the template vector(s) having the top few (e.g., top three) similarity metrics may be identified. The template(s) corresponding to the identified template context vector(s) may then be retrieved from the template database. If multiple templates are retrieved, each retrieved template may be associated with the similarity metric computed for the corresponding template vector. The similarity metric may be used in subsequent steps to rank the retrieved templates.

At 750, a context-grounded explanation is generated for each retrieved template. The context-grounded explanation(s) may be generated using the refined query (generated from step 710) as a source of relevant context. A trained NLP model may be used to generate the explanation(s). Step 750 may be performed using the explanation generator 400. Performing step 750 may include performing steps 752-754, for example.

At 752, for each retrieved template, the associated template metadata is combined with the refined query, to obtain a combined string. For example, the template metadata may be concatenated with the refined query (e.g., using the concatenate module 402 of the explanation generator 400). If there are multiple retrieved templates, this step is performed to obtain a combined string for each respective retrieved template.

At 754, an explanation is generated for each retrieved template using the respective combined string. For example, each combined string may be inputted to a trained NLP generative model (e.g., the second NLP generative model 404 of the explanation generator 400) to obtain a respective generated explanation. The generated explanation may be presented together with the respective retrieved template for user review, approval, rejection and/or modification (e.g., via a UI on the user device 10).

Optionally, at 762 user selection of one or more of the retrieved template(s) may be received. For example, the user may select (e.g., via a UI on the user device 10) the template(s) they wish to use for the optimization model.

In some examples, instead of receiving user selection of the retrieved template(s), the retrieved templates may be ranked according to the associated similarity metrics and the top-ranked templates (e.g., top 3 templates having highest similarity metrics) may be automatically selected or may be selected by default (which the user may further approve).

At 764, the structured model summary and contextual information are updated using the selected template(s). For example, if the initial query corresponds to a particular field of the structure model summary, then the particular field may be filled with the metadata and any symbolic content contained in the selected templates. Any metadata associated with the retrieved template(s) may also be used to update the contextual information (e.g., appended to the document containing the contextual information). The metadata may be simply appended at the end of the document, or may be appended to a relevant sentence that was detected to have the highest relevance and was used to generate the explanation.

Step 606, including steps 710, 730 and 750 and their respective sub-steps, may be repeated until all required fields in the structured model summary have been completed, or until an instruction (e.g., user input) is received to proceed to retrieving the base model template at step 608.

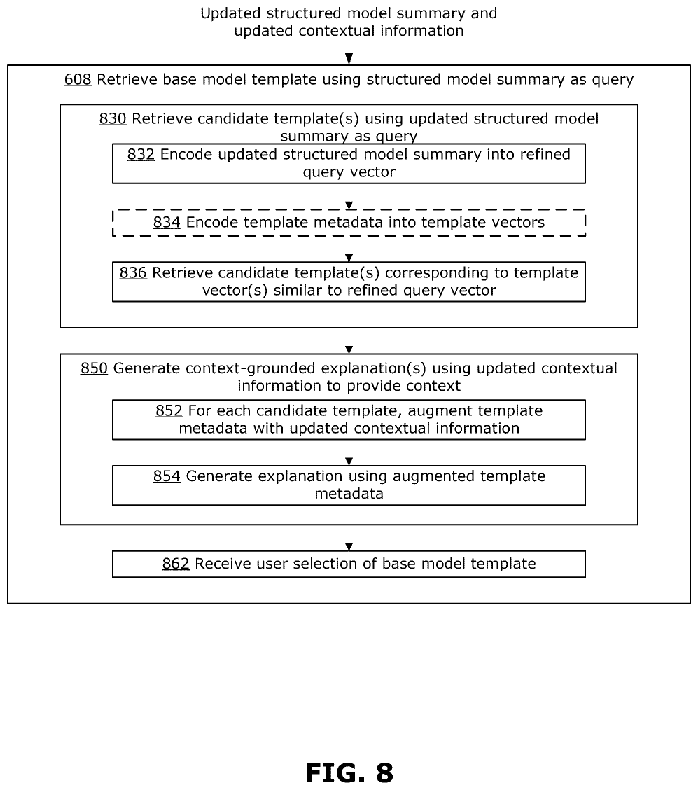

FIG. 8 illustrates details of example steps for performing step 608. The steps illustrated in FIG. 8 may be performed using the explainable template retrieval system 100, as discussed further below.

Prior to step 608, the structured model summary has been updated and the contextual information has been updated (e.g., at step 606 described above). Step 608 may be performed using steps 830 and 850, each of which may include sub-steps as discussed below.

At 830, one or more candidate templates are retrieved, using the updated structured model summary as a query to the template database 150. A trained NLP model may be used for performing the template retrieval. In step 830, the updated structured model summary may have a similar function to the refined query in step 730 discussed previously in that the updated structured model summary contains information for retrieving a relevant candidate for a base model template. Step 830 may be performed using the template retriever 300. Performing step 830 may include performing steps 832-836, for example.

At 832, the updated structured model summary is encoded into a refined query vector (which may also be referred to as a model summary vector) using a trained NLP encoder (e.g., using the second NLP encoder 302 of the template retriever 300).

Optionally, at 834, template metadata associated with candidate base model templates stored in a template database are encoded into respective template vectors using a trained NLP encoder (e.g., using the second NLP encoder 302 of the template retriever 300). In some examples, the template metadata may have been encoded into template vectors prior to the incremental modeling method 600 and stored in memory (e.g., in the template database 150); then, step 834 may be omitted and the previously generated template vectors may be obtained from the memory.

At 836, based on similarity between the refined query vector and each template vector (whether obtained from the memory or obtained by performing step 834), one or more candidate templates are retrieved corresponding to one or more template vectors that are similar to the refined query vector. This may be similar to step 736 discussed above and the details do not need to be repeated here.

At 850, a context-grounded explanation is generated for each candidate template. The context-grounded explanation(s) may be generated using the updated contextual information as a source of relevant context. A trained NLP model may be used to generate the explanation(s). Step 850 may be performed using the explanation generator 400. Performing step 850 may include performing steps 852-854, for example.

At 852, for each candidate template, the template metadata is augmented with context, to obtain an augmented template metadata. For example, if the updated contextual information is relatively short (e.g., no longer than one paragraph or within 500 words), the contextual information may be concatenated with the template metadata to obtain the augmented template metadata. In another example, context may be contained in the metadata of the structured model summary and the metadata of the structured model summary may be concatenated with the metadata of the candidate template to obtain the augmented template metadata. Alternatively or additionally the metadata associated with each model component of the candidate template may be paired with the metadata associated with a corresponding model component of the structured model summary (e.g., metadata of an entity in the candidate template may be paired with the metadata of a corresponding entity in the structured model summary). For example, the relevant context segment or refined query that was used for retrieving a particular entity for the structured model summary may be stored as metadata of the structured model summary. Then this metadata may be paired with the corresponding entity of the candidate template. Thus, the augmented template metadata may be set of paired model component metadata. In general, it should be understood that the augmented template metadata may be obtained in various ways and the examples described above are not intended to be limiting. If there are multiple candidate templates, this step is performed to obtain an augmented template metadata for each respective candidate template.

At 854, an explanation is generated for each candidate template using the respective augmented template metadata. For example, each augmented template metadata may be inputted to a trained NLP generative model (e.g., the second NLP generative model 404 of the explanation generator 400) to obtain a respective generated explanation. The generated explanation may be presented together with the respective retrieved candidate template for user review, approval, rejection and/or modification (e.g., via a UI on the user device 10).

At 862, user selection of one of the candidate template(s) may be received. For example, the user may select (e.g., via a UI on the user device 10) the base model template they wish to use as a basis for the optimization model. In some examples, instead of receiving user selection of the base model template, user approval of an automatically selected base model template may be received. For example, the retrieved candidate templates may be ranked according to the associated similarity metrics and the top-ranked template (e.g., the one candidate template having highest similarity metric) may be automatically selected or may be selected by default (which the user may approve). The selected candidate template is used as the base model template for building the optimization model.

The base model template has a base symbolic model and also template metadata (which may include metadata associated with the overall base model template as well as metadata associated with each model component of the base model template). The base model template may be used as the initial data structure for the optimization model (e.g., similar to the structured model summary) and may replace the structured model summary for keeping a record of selected model components. The symbolic model (and related model code) may be stored in a field of the optimization model's data structure and other fields may be used to store information about the model components. The optimization model may be built (e.g., using step 610) by retrieving templates for model components to be added to the optimization model and updating the symbolic model with symbolic content (e.g., model code) of each retrieved template. The structured model summary may be kept, for example as a basis for determining what templates should be added to the optimization model (e.g., the base model template, which is used as the initial optimization model, may initially omit templates that are found in the structured model summary). The structured model summary may also provide context that may be used to generate explanations when building the optimization model. It may be noted that although the optimization model may use the base model template as the starting point, the final optimization model may be different from the base model template.

Following step 608, the retrieved base model template may be used to build the optimization model at step 610 by using the base model template as the initial optimization model and adding retrieved template(s) for additional model component(s). Each addition of a model component to the optimization model incrementally updates optimization model (e.g., by adding the template and metadata of the additional model component to the data structure of the optimization model and adding code corresponding to the additional model component to the symbolic model).

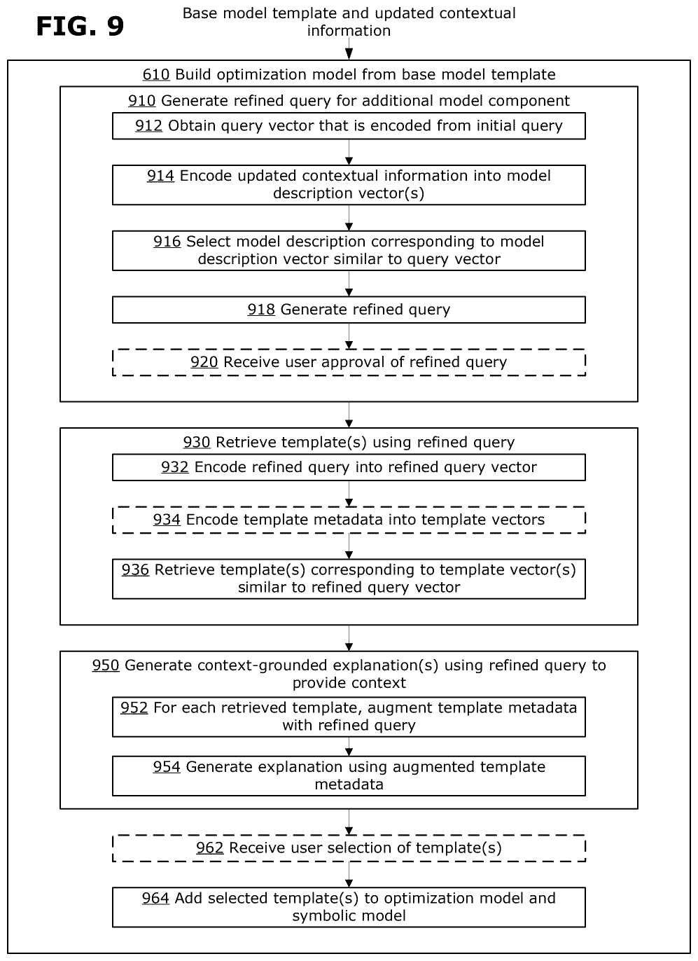

FIG. 9 illustrates details of example steps for performing step 610. The steps illustrated in FIG. 9 may be performed using the explainable template retrieval system 100, as discussed further below.

Prior to step 610, the base model template has been retrieved and selected as the starting point for generating the optimization model (e.g., at step 608 described above) and the updated contextual information has been generated (e.g., from step 606 described above). The optimization model may then be built up by adding model components (e.g., adding components one by one in an incremental or iterative manner) until the desired optimization model is obtained. Step 610 may be performed using steps 910, 930 and 950, each of which may include sub-steps as discussed below.

At 910, a refined query is generated to query for an additional model component that can be used to build the optimization model. The refined query contains information about the relevant context, which may be extracted from the updated contextual information using trained NLP models. Step 910 may be performed using the refined query generator 200. In some examples, performing step 910 may involve performing steps 912-920. Step 910 may be similar to step 710 described above.

At 912, a query vector is obtained. The query vector is obtained by encoding an initial query (which may be received from user input via the user device 10 or from a predefined list of queries).

For example, the initial query may be a predefined query based on, for example, model components that may be added to build the optimization model from the base model template. Thus, the initial query may be a predefined query for a particular model component that can be added to the optimization model. For example, the base model template may include some model components but may also define one or more additional model components that may be added to build the optimization model. For example, the base model template may include an objective (e.g., function to minimize or maximize) but may not include any constraints. The initial query may be a predefined query for a constraint to add to the model. If the initial query is from a predefined list of queries, the initial query may be presented to the user for the user's review and/or approval. In another example, the initial query may be received from user input via the user device 10. The initial query is encoded into a query vector using a trained NLP encoder (e.g., using the first NLP encoder 206 of the refined query generator 200). If the initial query is from a predefined list of queries, the query vector may have been generated using the trained NLP encoder and stored in memory prior to the incremental modeling method 600; the query vector may then be obtained at step 912 by retrieving the query vector from memory.

At 914, the updated contextual information is segmented into model description segments (e.g., using the segmentation module 204 of the refined query generator 200) and encoded into model description vectors using a trained NLP encoder (e.g., using the first NLP encoder 206 of the refined query generator 200). In some examples, the structured model summary may be used to provide context. The fields of the structured model summary may be segments of the structured model summary. The segmentation model 204 may, for example, format or otherwise process the fields of the structured model summary into segments that can be encoded by the trained NLP encoder into model description vectors.

At 916, based on similarity between the query vector and each model description vector, one or more model description segments are selected corresponding to one or more model description vectors that are similar to the query vector. This may be performed similar to step 716 described above.

At 918, a refined query is generated. For example, the selected model description segment(s) may be combined (e.g., concatenated) with the initial query. The combined string may be provided as input to a trained NLP generative model (e.g., the first NLP generative model 210 of the refined query generator 200) and a refined query is obtained. In this example, one refined query is generated. In other examples, there may be multiple refined queries generated (e.g., corresponding to multiple selected model description segments).

In some examples, the refined query may, instead of being generated from an initial query, be metadata associated with a template for a model component of the structured model summary that is currently omitted from the optimization model.

Optionally, at 920, user approval of the refined query may be received. For example, the generated refined query may be presented (e.g., via a UI on a user device 10) to the user to accept, reject or modify.

At 930, one or more templates are retrieved. The template(s) may be retrieved by using the refined query generated from step 920. A trained NLP model may be used for performing the template retrieval. Step 930 may be performed using the template retriever 300. Performing step 930 may include performing steps 932-936, for example.

At 932, the refined query (optionally after user approval and/or modification) is encoded into a refined query vector using a trained NLP encoder (e.g., using the second NLP encoder 302 of the template retriever 300).

At 934, template metadata associated with templates stored in a template database are encoded into respective template vectors using a trained NLP encoder (e.g., using the second NLP encoder 302 of the template retriever 300).

At 936, based on similarity between the refined query vector and each template vector, one or more templates are retrieved corresponding to one or more template vectors that are similar to the refined query vector. A retrieved template includes metadata and symbolic content that provides a symbolic representation of the model component. For example, a template for an object may include metadata “minimize travel time” and symbolic content {TYPE: objective, SENSE: minimize, VAR: x[i], PARAM: none} representing an objective with objective sense minimize and a 1-D decision variable.

At 950, a context-grounded explanation is generated for each retrieved template. The context-grounded explanation(s) may be generated using the refined query (generated from step 910) as a source of relevant context. A trained NLP model may be used to generate the explanation(s). Step 950 may be performed using the explanation generator 400. Performing step 950 may include performing steps 952-954, for example.

At 952, for each retrieved template, the associated template metadata is augmented with the refined query. For example, the template metadata may be concatenated with the refined query (e.g., using the concatenate module 402 of the explanation generator 400). If there are multiple retrieved templates, this step is performed to obtain a combined string for each respective retrieved template.

At 954, an explanation is generated for each retrieved template using the respective augmented template metadata. For example, each augmented template metadata may be inputted to a trained NLP generative model (e.g., the second NLP generative model 404 of the explanation generator 400) to obtain a respective generated explanation. The generated explanation may be presented together with the respective retrieved template for user review, approval, rejection and/or modification (e.g., via a UI on the user device 10).

Optionally, at 962 user selection of one or more of the retrieved template(s) may be received. For example, the user may select (e.g., via a UI on the user device 10) the template(s) for the model component(s) they wish to add to the optimization model.

In some examples, instead of receiving user selection of the retrieved template(s), the retrieved templates may be ranked according to the associated similarity metrics and the top-ranked templates (e.g., top 3 templates having highest similarity metrics) may be automatically selected or may be selected by default (which the user may further approve).

At 964, the selected template(s) is added to the optimization model and symbolic model. For example, if a selected template is a template for a particular model component, the metadata for that model component may be added to the optimization model and the symbolic content of that model component may be added to the symbolic model.

Step 610, including steps 910, 930 and 950 and their respective sub-steps, may be repeated to continue building the optimization model until user input is received to approve the optimization model. For example, after each iteration of step 610, the current state of the optimization model may be checked to determine if there are any model components that may need to be added and/or the user may be prompted (e.g., via a UI on the user device 10) to approve or continue building the model. For example, the model components in the current optimization model may be compared against a predefined list of commonly used or expected model components associated with the base model template, and any model component in the predefined list that is not in the current optimization model may be identified as a model component that may be added to the optimization model. In another example, the current optimization model may be compared against the structured model summary, and any model components found in the structured model summary but not found in the current optimization model may be identified as a model component that may be added to the optimization model. In another example, the user may be prompted to provide information that may be used to identify a model component that may be added to the optimization model. When the optimization model has been sufficiently built and approved by the user, the optimization model may then be outputted (e.g., saved and/or instantiated). The optimization model may be outputted together with the final updated contextual information (i.e., the contextual information that has been appended with information from the template metadata). The updated contextual information may provide information that links the model components to particular context segments, which may help the user to understand the generated optimization mode. The updated contextual information may also serve as a record of how the optimization model was built and as documentation for the optimization model.

Examples of the present disclosure may enable a non-OR expert to generate an optimization model from an unstructured, natural language description of the optimization problem. This may help to improve the accessibility of existing solvers by enabling non-OR experts to generate optimization models that can then be instantiated into model instances to be solved by solvers.

In some examples, a UI may be provided to enable the user to interact with the explainable template retrieval system 100 and the incremental modeling method 600, such as to provide user input and view generated explanations. The UI may be part of a modeling assistant service that may be accessed by the user device 10 over a wireless network, for example, where the explainable template retrieval system 100 and the incremental modeling method 600 are provided as a cloud-based service or online service to a user.

Examples of UIs disclosed herein may provide natural language prompts to a user to provide the contextual information (e.g., a textual description of the optimization problem, business domain, and any other relevant information), for example by uploading a text document or by inputting into a text editing field. Example UIs may provide prompts to the user to review, edit and/or approve refined queries for model components, and may provide prompts with context-grounded explanations to the user to review and/or approve retrieved templates. The example UIs may provide the user options for modifying an optimization model, such as adding constraints and objectives. Example UIs may also enable the user to provide natural language inputs describing model components to be added to the optimization model.

Some examples of the UI are now described, however these are not intended to be limiting.

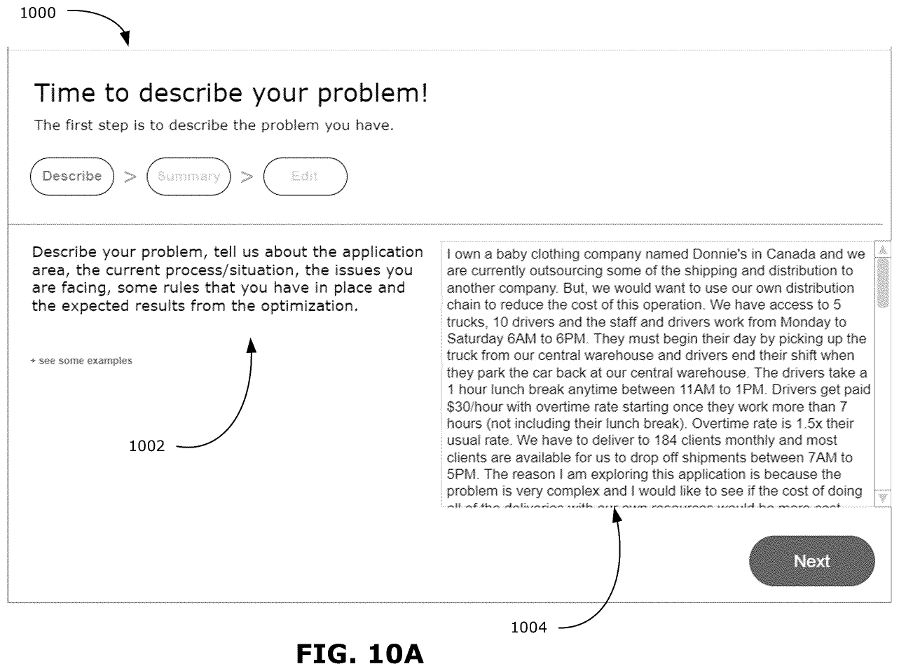

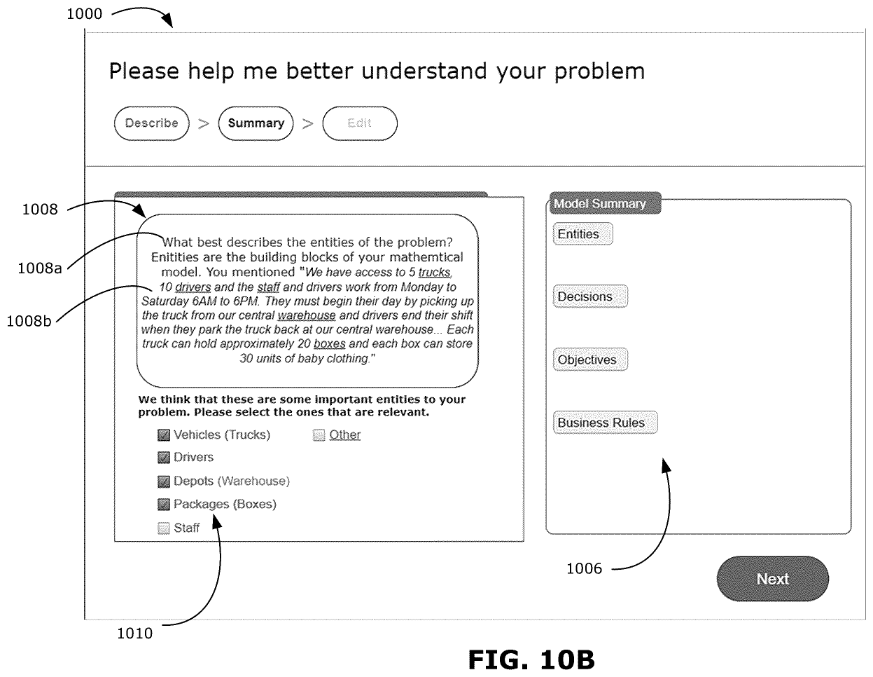

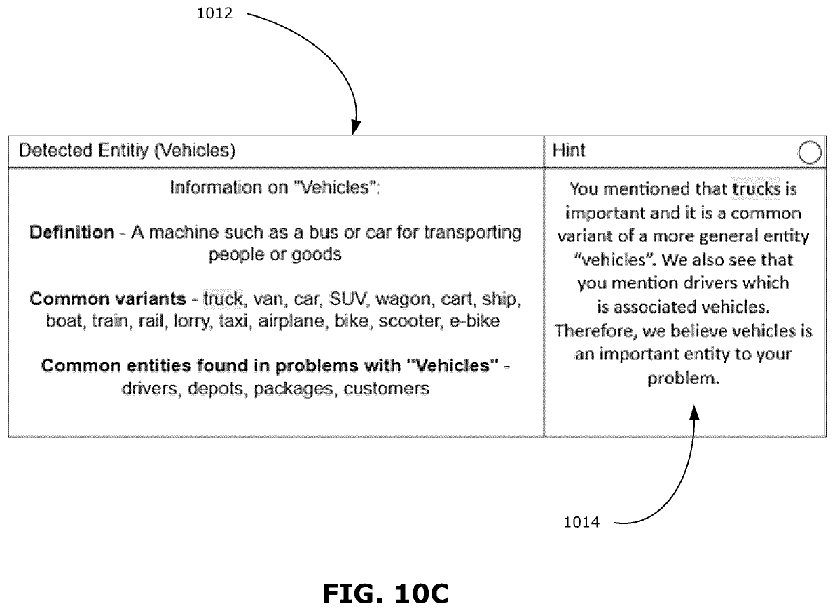

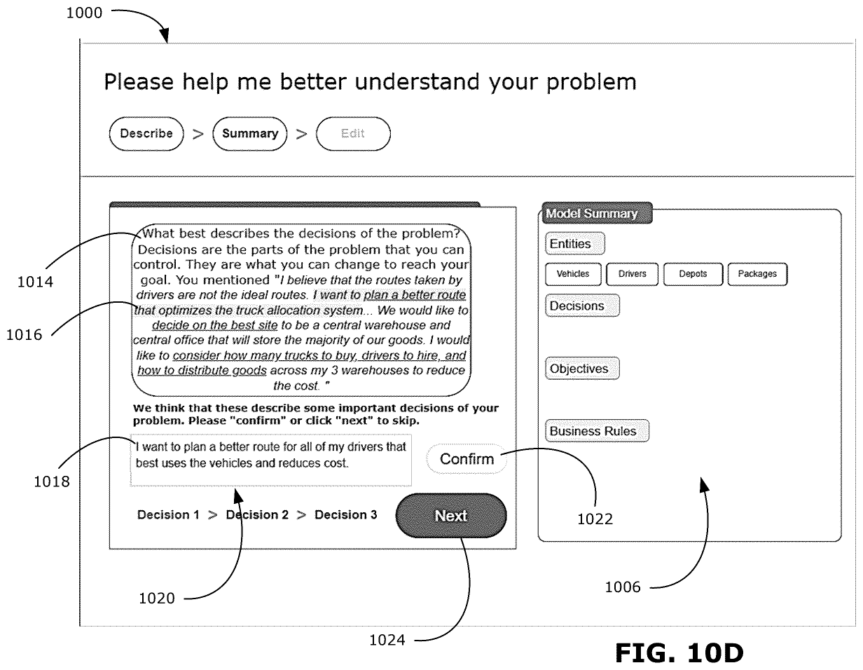

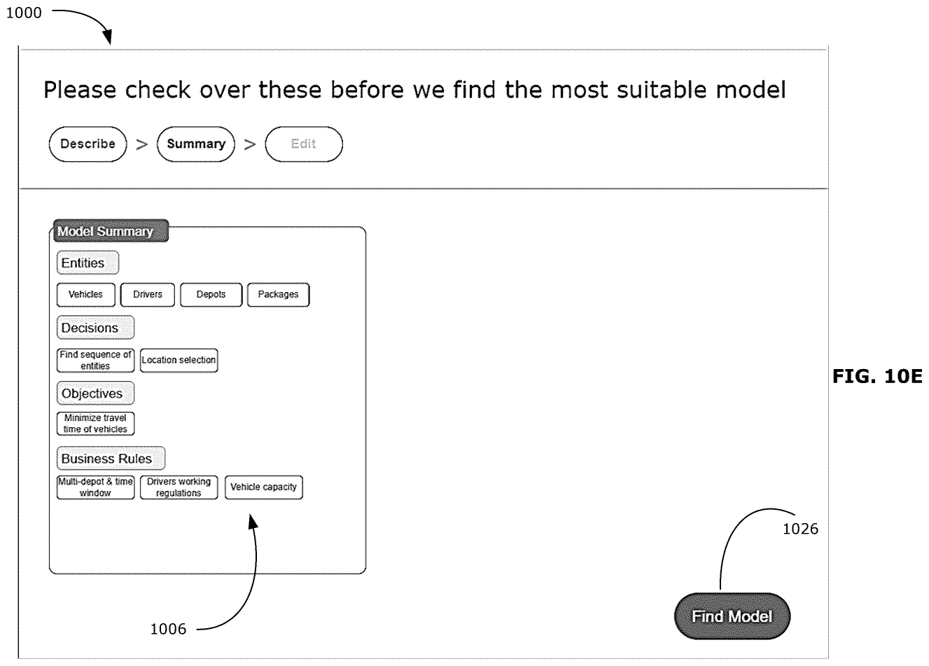

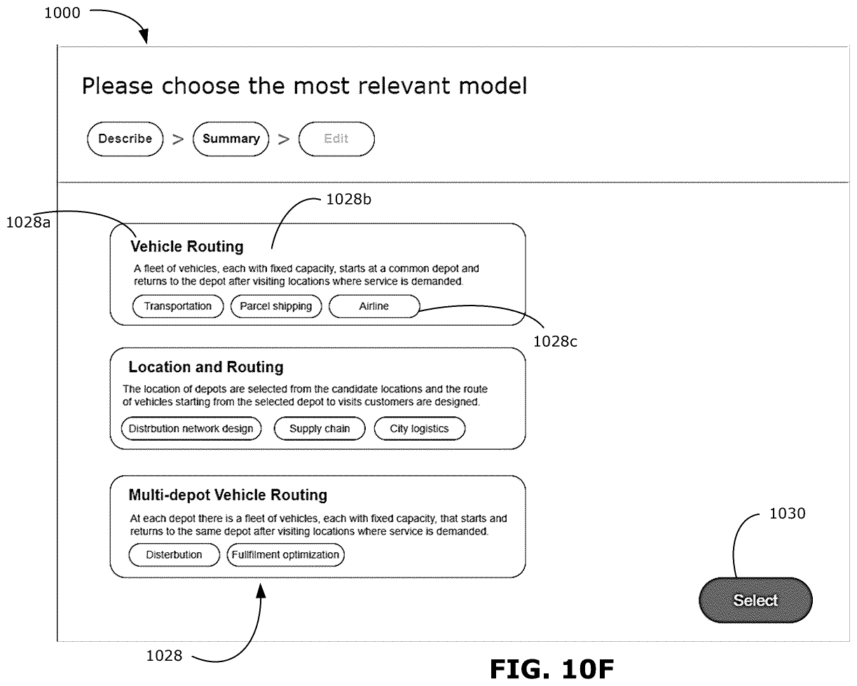

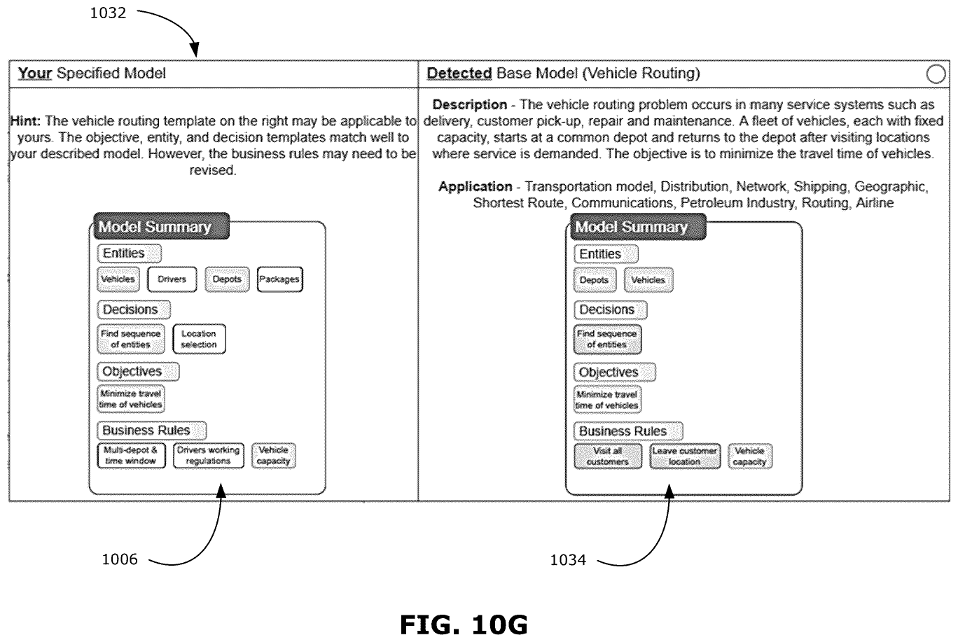

FIG. 10A illustrates a first screen of an example UI 1000 in which a user is prompted to provide contextual information for an optimization problem. The UI 1000 may include a natural language prompt 1002 to the user and may include a text editing field 1004 in which the contextual information may be inputted. In some examples, the UI 1000 may additionally or alternatively provide an option for the user to upload a text document containing the contextual information.

FIG. 10B illustrates a second screen of the example UI 1000, which may be presented during the structured model summary clarification stage (e.g., at step 606 described previously). The UI 1000 includes a visual representation of the structured model summary 1006 (which in this example has been initialized and does not yet contain any templates for any model components—as illustrated by the “entities”, “decision”, “objectives” and “business rules” fields being blank). The UI 1000 also displays a refined query 1008 which in this example includes a generic initial query 1008a (“What best describes the entities of the problem?”) with a predefined generic definition of the initial query, and is concatenated with context 1008b extracted from the contextual information. The UI 1000 also provides selectable options 1010 for the user to select templates to be added to the structured model summary. The selectable options 1010 may be generated according to the metadata of templates that have been retrieved.

FIG. 10C illustrates an example pop-up window 1012 of the UI 1000. The example pop-up window 1012 may provide, for example, a context-grounded explanation 1014 for a particular retrieved template for a model component (in this example, a model entity related to “vehicles”) that may be used to populate the structured model summary data structure. In this example, the pop-up window 1012 also provides predefined text related to the template (e.g., the metadata associated with the template), which in this example is a definition of the template that may be added to the structured model summary. For example, the pop-up window 1012 may be displayed in response to user selection of a corresponding selectable option 1010 of the UI 1000.

FIG. 10D illustrates a third screen of the example UI 1000. In this example, the structured model summary 1006 has been populated with retrieved templates for entities (e.g., templates for the entities “vehicles”, “drivers”, “depots” and “packages”). The UI 1000 displays an initial query 1014 and relevant context 1016 that are used to generate a refined query 1018 for retrieving a template for a decision. The refined query 1018 is displayed for the user to review, edit and/or approve. In this example, the refined query 1018 is displayed in a text editing field 1020, such that the user may directly edit the refined query 1018. A selectable option 1022 is also provided to enable the user to approve the refined query 1018 (with or without editing by the user). Another selectable option 1024 may be provided that may enable the user to skip the generated refined query 1018 (e.g., if the user wishes to consider a different query first).

In response to selection of the option 1022 to approve the refined query (with or without editing by the user), the refined query may be used by the explainable template retrieval system 100 to retrieve a relevant template. A context-grounded explanation for the retrieved template may be displayed for the user to review, for example in a pop-up window similar to the example pop-up window 1012 illustrated in FIG. 10C. The user may be provided with options to approve the retrieved template, which may then be used to populate the structured model summary 1006. In this way, the structured model summary 1006 may be incrementally updated with templates for different model components.

FIG. 10E illustrates an example fourth screen of the example UI 1000, which may enable the user to review the structured model summary 1006. In this example, the structured model summary 1006 has been updated to include templates for the entities “vehicles”, “drivers”, “depots” and “packages”; templates for the decisions “find sequence of entities” and “location selection”; templates for the objective “minimize travel time of vehicles”; and templates for the business rules (which may also be referred to as constraints) “multi-depot & time window”, “drivers working regulations” and “vehicle capacity”. Each of the templates displayed in the structured model summary 1006 may be selectable by the user, and selection of a particular templates may cause the UI 1000 to provide a pop-up window displaying the context-grounded explanation for that particular templates (which was previously generated when the template was retrieved). The UI 1000 may provide selectable options (not shown) for removing a particular template from the structured model summary and/or to query for other templates that may be added to the structured model summary. The UI 1000 also provides a selectable option 1026 for the user to provide approval of the structured model summary. In response to user approval of the structured model summary, the explainable template retrieval system 100 uses the structured model summary as a query to retrieve one or more base model templates.

FIG. 10F illustrates an example fifth screen of the example UI 1000, which may be displayed after one or more base model templates have been retrieved by the explainable template retrieval system 100. In this example, each of the retrieved templates 1028 are displayed with a title 1028a, a generated explanation 1028b and indication of the relevant domains 1028c. The user may select one of the displayed base model templates 1028 (e.g., by clicking on one of the displayed templates 1028) and select an option 1030 to approve the use of the selected base model template 1028 as a basis for building the optimization model.

FIG. 10G illustrates an example pop-up window 1032 that may be displayed to provide more information about the base model templates 1028 illustrated in FIG. 10F. For example, the pop-up window 1032 may be displayed when one of the base model templates 1028 is selected but not yet approved by the user. In this example, the pop-up window 1032 provides a side-by-side comparison of the structured model summary 1006 (e.g., the structured model summary 1006 that was approved by the user to query for the base model template, for example as shown in FIG. 10E) and a base model summary 1034 of one of the base model templates 1028 that has been retrieved. The pop-up window 1032 provides an explanation of the base model template (e.g., a context-grounded explanation of the base model template, which may have been generated when the base model template was retrieved).

The pop-up window 1032 also enables a visual comparison between the structured model summary 1006 approved by the user and the base model summary 1034 of the base model template. For example, model components that are common between the structured model summary 1006 and the base model summary 1034 may be highlighted in green; model components that are found in the structured model summary 1006 but not in the base model summary 1034 may be displayed in white; and model components that are found in the base model summary 1034 but not in the structured model summary 1006 may be displayed in red. Each of the model components displayed in the pop-up window 1032 may be selectable by the user, to call up a further pop-up window (not shown) that provides the context-grounded explanation for the template corresponding to the selected model component. This may enable the user to better understand the relevance of a retrieved base model template.

Returning to FIG. 10F, after one of the base model templates 1028 has been selected and approved by the user, the UI 1000 may enable the optimization model to be incrementally built from the base model template by querying and retrieving additional templates. This may be similar to the process for adding templates to the structured model summary, for example as illustrated by the examples of FIGS. 10B-10D. When the user is satisfied with the optimization model and no further additional templates need to be added, the user may be provided with an option to approve the final optimization model and output the optimization model as a symbolic model. The contextual information may also be outputted with annotations (automatically inserted by the explainable template retrieval system 100, as described above), to provide documentation for the generated optimization model.

Although an example UI 1000 has been illustrated and described, it should be understood that this is not intended to be limiting. For example, the explainable template retrieval system 100 and/or the incremental modeling method 600 may be provided with or without any UI. Additionally or alternatively, any UI that supports natural language textual inputs from a user may be suitable for examples of the present disclosure.

In various examples, the present disclosure describes systems and methods that enables an optimization model to be generated. The optimization model may be generated in an incremental (or iterative) fashion, with templates being used as building blocks. Each template may be presented to a user with context-grounded explanation, which may enable a user to understand the meaning of the template in the context of a particular optimization problem.

Examples of the present disclosure enables a user to make use of optimization solvers, by enabling an optimization model to be generated (which may be instantiated into a model instance to be solved by solvers), without requiring the user to directly code the optimization model. Examples of the present disclosure enable natural language inputs to be accepted as input, which may result in solvers becoming more accessible to users.

Examples of the present disclosure provide a flexible framework for generating an optimization model. There is no fixed decision tree that must be traversed in order to arrive at the final optimization model. Further, examples of the present disclosure may enable an optimization model to be modified and/or refined at various stages and in a modular manner (e.g., by modifying, adding or removing templates). This may enable optimization models to be generated in a more efficient manner. For example, rather than having the user approve a fully generated optimization model (and thus having to re-generate the entire optimization model from scratch if a change is needed), the user may be involved through the entire process of model generation and it may be possible for a user to review and approve individual templates that are used to build up the optimization model. The user may be guided in the model generation process through the generation of context-grounded explanations for each retrieved template. Thus, the need to regenerate the optimization model from scratch due to user modifications may be reduced or avoided.

In some examples, the contextual information that provides the context of the optimization problem may be automatically annotated with information about the templates used to generate the optimization model. The annotated contextual information may serve as documentation for the optimization model, and a record of how the optimization model was generated. Such self-documenting capability may be useful to automatically generate a supporting document for the optimization model that contains both the context of the problem and also technical explanations of the optimization model. The auto-generation of such documentation is advantageous in reducing the amount of manual input required.

Although examples have been described in which the inputted markup document is an unstructured, multimodal document, it should be understood that the present disclosure may also be applicable in cases where the markup document is structured (e.g., follows specific rules for definition the optimization problem), or contains only math content, for example.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computing system comprising:
a processing unit configured to execute computer-readable instructions to cause the system to:
receive, from a user device, contextual information containing a textual description of an optimization problem in natural language;
update a structured model summary data structure by retrieving, from a template database, one or more templates for one or more model components, each of the one or more templates being retrieved using a respective refined query generated from the contextual information, and updating the structured model summary data structure using metadata associated with each of the retrieved one or more templates;
retrieve a base model template using the structured model summary data structure as a query to the template database;
update a symbolic model associated with the base model template by retrieving, from the template database, one or more additional templates for one or more additional model components, each of the one or more templates being retrieved using a respective additional refined query, and updating the symbolic model using symbolic content associated with each of the retrieved one or more templates; and
output the symbolic model as a generated optimization model.

2. The computing system of claim 1, wherein updating the structured model summary data structure includes updating the contextual information using metadata associated with the retrieved one or more templates, and wherein the updated contextual information is outputted.

3. The computing system of claim 1, wherein updating the structured model summary data structure is performed iteratively, and wherein the structured model summary data structure is updated using metadata associated with one retrieved template for one model component in each iteration.

4. The computing system of claim 3, wherein updating the symbolic model is performed iteratively, and wherein the symbolic model is updated using symbolic content associated with one retrieved template for one model component in each iteration.

5. The computing system of claim 1, wherein updating the structured model summary data structure includes generating a context-grounded explanation for each retrieved one or more templates, and wherein the context-grounded explanation is presented via the user device.

6. The computing system of claim 1, wherein updating the structured model summary data includes presenting, via the user device, at least one refined query, and receiving approval, via the user device, of the at least one refined query prior to using the at least one refined query to retrieve a respective at least one template.

7. The computing system of claim 1, wherein the processing unit is further configured to executing computer-readable instructions to cause the system to:
after retrieving the base model template, present, via the user device, a generated explanation for the base model template, the generated explanation being generated from metadata associated with the base model template and the contextual information.

8. The computing system of claim 1, wherein updating the symbolic model includes presenting, via the user device, at least one additional refined query, and receiving approval, via the user device, of the at least one additional refined query prior to using the at least one additional refine query to retrieve a respective at least one template.

9. The computing system of claim 1, wherein the at least one refined query is generated from an initial query received from the user device.

10. The computing system of claim 1, wherein the processing unit is further configured to execute computer-readable instructions to cause the system to:
provide a user interface (UI) to the user device, wherein the contextual information is received as natural language input from the user device via the UI.

11. The computing system of claim 1, wherein the processing unit is further configured to execute computer-readable instructions to cause the system to implement a refined query generator comprising:
a first natural language processing (NLP) encoder trained to encode context segments, segmented from the contextual information, into respective context vectors and to encode an initial query into a query vector, wherein the context vectors and the query vector are encoded into a common vector space;
a first similarity module configured to select at least one selected context segment based on a similarity between the query vector and the context vector encoded from the at least one selected context segment; and
a first NLP generative model trained to generate at least one refined query based on the initial query and the at least one selected context segment.

12. The computing system of claim 11, wherein the processing unit is further configured to execute computer-readable instructions to cause the system to implement a template retriever comprising:
a second NLP encoder trained to encode the at least one refined query into a refined query vector and to encode metadata associated with each one or more templates into respective one or more template vectors, wherein the one or more template vectors and the refined query vector are encoded into a common vector space; and
a second similarity module configured to select at least one selected template to be retrieved based on a similarity between the refined query vector and the template vector encoded from metadata associated with the at least one selected template.

13. The computing system of claim 12, wherein the processing unit is further configured to execute computer-readable instructions to cause the system to implement an explanation generator comprising:
a second NLP generative model trained to generate a context-grounded explanation for the at least one selected template based on the metadata associated with the at least one selected template and the refined query.

14. A method comprising:
receiving, from a user device, contextual information containing a textual description of an optimization problem in natural language;
updating a structured model summary data structure by retrieving, from a template database, one or more templates for one or more model components, each of the one or more templates being retrieved using a respective refined query generated from the contextual information, and updating the structured model summary data structure using metadata associated with each of the retrieved one or more templates;
retrieving a base model template using the structured model summary data structure as a query to the template database;
updating a symbolic model associated with the base model template by retrieving, from the template database, one or more additional templates for one or more additional model components, each of the one or more templates being retrieved using a respective additional refined query, and updating the symbolic model using symbolic content associated with each of the retrieved one or more templates; and
outputting the symbolic model as a generated optimization model.

15. The method of claim 14, wherein updating the structured model summary data structure includes updating the contextual information using metadata associated with the retrieved one or more templates, and wherein the updated contextual information is outputted.

16. The method of claim 14, wherein updating the structured model summary data structure includes generating a context-grounded explanation for each retrieved one or more templates, and wherein the context-grounded explanation is presented via the user device.

17. The method of claim 14, further comprising:
after retrieving the base model template, presenting, via the user device, a generated explanation for the base model template, the generated explanation being generated from metadata associated with the base model template and the contextual information.

18. The method of claim 14, wherein updating the symbolic model includes presenting, via the user device, at least one additional refined query, and receiving approval, via the user device, of the at least one additional refined query prior to using the at least one additional refine query to retrieve a respective at least one template.

19. The method of claim 14, further comprising executing a refined query generator comprising:
a first natural language processing (NLP) encoder trained to encode context segments, segmented from the contextual information, into respective context vectors and to encode an initial query into a query vector, wherein the context vectors and the query vector are encoded into a common vector space;
a first similarity module configured to select at least one selected context segment based on a similarity between the query vector and the context vector encoded from the selected context segment; and
a first NLP generative model trained to generate at least one refined query based on the initial query and the at least one selected context segment.

20. The method of claim 19, further comprising executing a template retriever comprising:
a second NLP encoder trained to encode the at least one refined query into a refined query vector and to encode metadata associated with each one or more templates into respective one or more template vectors, wherein the one or more template vectors and the refined query vector are encoded into a common vector space; and
a second similarity module configured to select at least one selected template to be retrieved based on a similarity between the refined query vector and the template vector encoded from metadata associated with the at least one selected template.
